(19) United States
(12) Patent Application Publication
(10) Pub. No.: US 2003/0117337 A1
(43) Pub. Date: Jun. 26, 2003

(54) Antenna screen structures and method for producing same

(76) Inventor: Brent W. Lendriet, Chandler, AZ (US)

Correspondence Address: Jordan M. Meschkow, MESCHKOW & GRESHAM, P.L.C., Suite 409, 5727 N. 7th Street, Phoenix, AZ, 85014, US

(21) Appl. No.: 10/028,635

(22) Filed: Dec. 20, 2001

(51) Int. Cl. H01Q 1/42

(52) U.S. Cl. 343/872

(57) ABSTRACT

An antenna screen structure (20) includes a screen face (28) and a peripheral support (30) integral to the screen face (28) to form a single unit. The screen face (28) is a low mass, but stiff cored construct that includes a first FRP layer (52), a second FRP layer (54), and a thermoplastic honeycomb core layer (56) interposed between first and second FRP layers (52) and (54). The peripheral support (30) generally includes horizontal and vertical flange members surrounding a periphery of the screen face (28). Stiffeners in the form of first and second beam members (64, 66) may replace the horizontal flange members, or may be utilized as an additional horizontal intermediate support member (68). Various configurations of antenna screen structures that are adapted from the antenna screen structure (20) include a parapet mounted two-sided antenna screen structure (122), pole-mounted triangular and cylindrical antenna screen structures (168, 230), a box-shaped antenna screen structure (280), and one-sided parapet mounted antenna screen structures (294, 314). The various antenna screen structures are evaluated to assess structural integrity, weight, and cost using an antenna screen evaluation routine (338), and are fabricated in a mold (428) created on a tooling table system (404).

### TECHNICAL FIELD OF THE INVENTION

The present invention relates to the field of radio frequency (RF) antenna systems. More specifically, the present invention relates to structures and methods for concealing RF antenna systems.

### BACKGROUND OF THE INVENTION

Cellular communications networks utilize radio frequency (RF) antenna systems at “cell sites” to transmit and receive RF signals. Cell sites are typically spaced from three to eight miles apart to achieve acceptable results. Consequently, a large metropolitan area can include hundreds of individual cell sites to insure thorough coverage. RF antenna systems are typically attached to the sides or rooftops of buildings, or are mounted on new or existing tower structures. The RF antenna systems are generally enclosed in housings to prevent the antennas from being damaged by the environment or mishandling. These housings often have the unsightly appearance of large boxes on sides of buildings and rooftops, or hanging from towers. To compound the problem, an array of antennas of varying sizes and shapes for several different systems are often found on a common tower.

The general public and the municipal zoning boards are becoming increasingly and vehemently intolerant of RF antenna systems and antenna towers in their communities. This intolerance is due to the visual undesirability of the systems and the perception that the presence of the antenna systems and towers has an adverse effect on local property values. These opinions increase the resistance to building additional sites within communities to provide service to the ever rising number of wireless communications subscribers.

The preferred locations for placement of RF antenna systems are typically the tallest available locations relative to the surrounding terrain within the intended coverage area. The tallest available location ensures that the line of sight will most likely be free of obstructions that may reflect electromagnetic waves from the direction of the desired coverage. Antennas mounted on the sides or roofs of buildings or mounted on towers atop the most prominent, visible locations within the surrounding landscape greatly exacerbates the aesthetics problem.

To reduce the objectionable aesthetics of RF antenna systems, concealment strategies have been attempted to make them blend within the existing architecture of a building or a location. Such concealment attempts include hiding antennas behind “screen” structures and within church steeples and bell towers, mounting antennas on streetlamps, decorative towers, and utility poles, disguising conventional antennas as flagpoles and trees, and so forth. Such strategies have achieved only limited success in terms of aesthetics because disguises often do not appear natural and because of the limited availability of existing structures onto which antennas may be mounted.

In addition to aesthetic effectiveness, the successful concealment of RF antenna systems entails the consideration of a number of constraints when designing, fabricating, and mounting antenna screen structures. These constraints include, for example, the structural soundness within the requirements of the local and/or regional building codes, the introduction of minimal detrimental effects on the RF signal, the ability to resist degradation from environmental effects, and the capability for relatively quick installation. Ideally, all of these constraints should be satisfied, or balanced, while maintaining economic viability.

One typical concealment approach is to use multiple common structural elements made from fiber reinforced plastic (FRP), such as, angle, channel, tubing, I-beams, and plates. Using these elements, a screen structure is designed and assembled as though the structural elements were metal pieces. Unfortunately, such a design requires hundreds, and even thousands of fasteners, to hold it together, thus increasing the complexity and cost of assembly.

Another concealment approach is a hybrid of the multiple elements approach. This hybrid approach reduces some of the complexity of the multiple elements approach and improves the aesthetics by making modular wall panels arranged in long rows. This hybrid approach uses a minimal amount of custom tooling (molds), thus decreasing the cost of the screen structures over the multiple elements approach.

In order to enhance customer satisfaction, RF signal degradation in the cellular network should desirably be kept at a minimum. The placement of any matter, including screen structures, will present some degree of adverse effect on RF signals. A predominant factor that affects RF signals is the cross-sectional mass of the material. That is, the greater the mass between an antenna and a receiver, the greater the effect on the signal. This problem of cross-sectional mass is exacerbated when beams and columns that support the screen structure are in the signal path. A horizontal beam in the signal path can introduce a small signal disturbance, generally in the form of a phase-shift. In contrast, vertical columns (and diagonal brackets) in the signal path introduce significant RF attenuation and phase shift. The multiple element concealment approach and the hybrid approach can suffer from RF degradation due to the beams and columns in the signal path that are used to fabricate the screen structures.

Radio system planners are typically required to perform a structural analysis of a proposed configuration of an antenna screen structure to evaluate the stresses and strains to which the proposed screen structure will or might be subjected. The analysis of a multiple element construct of a structure typically employs familiar conventions used in the analysis of structures of metal, wood, concrete, and so forth. Unfortunately, these familiar conventions do not capitalize on the properties of the materials used to manufacture RF transparent screen structures. In addition, a multiple element construct of a screen structure, such as the multiple element and the hybrid concealment approaches, may undesirably complicate the structural analysis, thus increasing the time and costs associated with performing such an analysis. Furthermore, changes to the configuration of the proposed screen structure that demand further structural analysis may also result in adverse time and cost affects.

### SUMMARY OF THE INVENTION

Accordingly, it is an advantage of the present invention that screen structures for concealing a cell site radio frequency antenna are provided.

It is another advantage of the present invention that the screen structures are configured to mitigate the potential for RF signal degradation.

It is another advantage of the present invention that a method is provided for producing the screen structures that rapidly assesses structural integrity and cost information of various configurations of the screen structures.

Another advantage of the present invention is that a method is provided that balances aesthetic effectiveness, RF degradation potential, structural integrity, and cost considerations in the design, fabrication, and installation of screen structures.

Yet another advantage of the present invention is that a method is provided that utilizes a tooling system for fabricating the screen structures that is readily and cost effectively arranged for the various configurations of the screen structures.

The above and other advantages of the present invention are carried out in one form by a screen structure for concealing a cell site radio frequency (RF) antenna at a location. The screen structure includes an RF transparent screen face and a peripheral support integral to an edge of said screen face, the RF transparent screen face and the peripheral support forming a single unit.

The above and other advantages of the present invention are carried out in another form by a method of producing an antenna screen structure for concealing a cell site radio frequency (RF) antenna at a location. The method calls for defining geometrical parameters of a configuration of the antenna screen structure and evaluating the configuration to determine whether the configuration exhibits acceptable structural integrity. When the configuration exhibits acceptable structural integrity, the method further calls for arranging a tooling table system to create a mold for the configuration of the antenna screen structure and utilizing the mold to fabricate the antenna screen structure from fiber reinforced plastic (FRP) . A surface finish is integrated into the antenna screen structure to imitate appearance of a structure at the location.

The above and other advantages of the present invention are carried out in yet another form by a tooling table system for producing an antenna screen structure configured to conceal a cell site radio frequency (RF) antenna, the antenna screen structure having an RF transparent screen face and a peripheral support integral to an edge of the screen face. The tooling table system includes a frame structure, a deck coupled to and overlying the frame structure, and a replaceable surface material overlying the deck. The tooling table system further includes a plurality of wall forms wherein selected ones of the wall forms are arranged upon the disposable surface material and attached to the deck to form a mold for a configuration of the antenna screen structure.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 shows a perspective front view of an antenna screen structure for concealing a cell site radio frequency antenna;

FIG. 2 shows a sectional side view of a first configuration of the antenna screen structure of FIG. 1;

FIG. 3 shows a sectional side view of a second configuration of the antenna screen structure of FIG. 1;

FIG. 4 shows a sectional side view of a third configuration of the antenna screen structure of FIG. 1;

FIG. 5 shows a perspective rear view of a vertical beam configuration of the antenna screen structure of FIG. 1;

FIG. 6 shows a perspective view of a second antenna screen structure;

FIG. 7 shows a perspective front view of a third antenna screen structure;

FIG. 8 shows a perspective rear view of the antenna screen structure of FIG. 7;

FIG. 9 shows a perspective rear view of a fourth antenna screen structure;

FIG. 10 shows a sectional top view of flange joint formed between first and second substructures of the antenna screen structure of FIG. 9;

FIG. 11 shows a perspective view of a fifth antenna screen structure having a triangular configuration;

FIG. 12 shows a sectional top view of another flange joint formed between vertical flange members of the fifth antenna screen structure of FIG. 11;

FIG. 13 shows a perspective view of a sixth antenna screen structure having a cylindrical configuration;

FIG. 14 shows an exploded perspective view of a sixth antenna screen structure having a box-shaped configuration;

FIG. 15 shows a perspective view of the box-shaped sixth antenna screen structure of FIG. 16 mounted on a tower;

FIG. 16 shows a perspective rear view of a seventh antenna screen structure;

FIG. 17 shows a perspective view of an eighth antenna screen structure;

FIG. 18 shows a flow chart of an antenna concealment process;

FIG. 19 shows a flow chart of an antenna screen evaluation routine;

FIG. 20 shows a table of summary values generated through the execution of the antenna screen evaluation routine;

FIG. 21 shows a perspective view of a tooling table system for producing an antenna screen structure; and

FIG. 22 shows an enlarged perspective view of a portion of the tooling table system of FIG. 21.

### DETAILED DESCRIPTION OF THE PREFERRED EMBODIMENTS

Many major cities either already have, or will have, codes that demand concealment of a cell site. The concealment of an cell site radio frequency (RF) antenna is a complex aspect of building a cell site for a telecommunications provider. When developing an antenna screen structure, the telecommunications provider must ideally balance aesthetic effectiveness, structural requirements, transparent RF properties, quick turn-around time, and reasonable cost. To further complicate the situation, each potential cell site is unique. That is, no single antenna screen structure design, shape, size, finish, color, or attachment method will suffice for the vast variety of cell site installation locations.

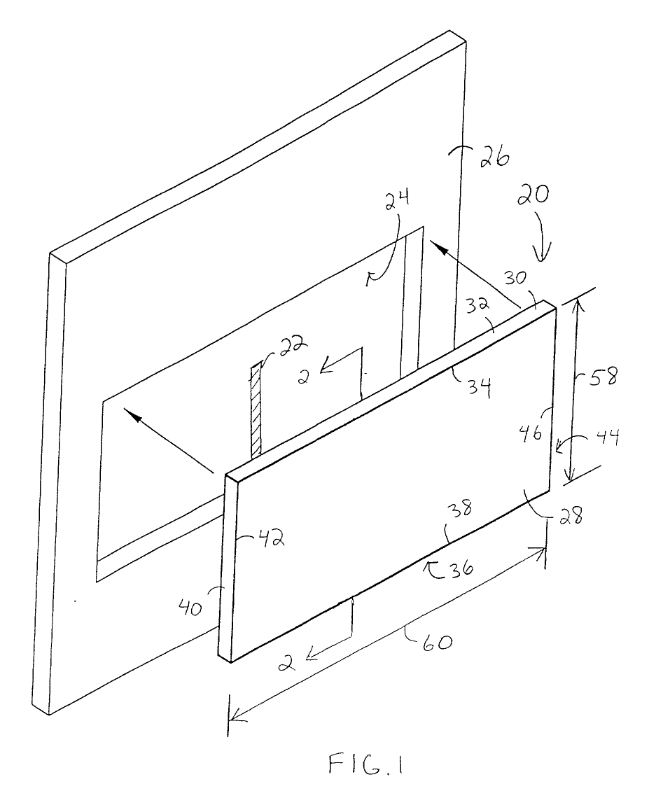

FIGS. 1-17 show various configurations of antenna screen structures in accordance with the present invention that may be used to conceal a cell site RF antenna. In addition, the present invention provides methodology and tooling for producing antenna screen structures, such as those illustrated in FIGS. 1-17.

FIG. 1 shows a perspective front view of an antenna screen structure 20 for concealing a cell site RF antenna 22. Antenna screen structure 20 is configured to fit at a specified location 24, or opening, in the side of a building 26.

Antenna screen structure 20 includes an RF transparent screen face 28 and a peripheral support 30 integral to screen face 28. More particularly, peripheral support 30 includes a first horizontal flange 32 on an upper edge 34 of screen face 28 and a second horizontal flange 36 on a lower edge 38 of screen face 28. In addition, peripheral support 30 includes a first vertical flange 40 on a first side edge 42 of screen face 28 and a second vertical flange 44 on a second side edge 46 of screen face 28.

In a preferred embodiment, screen face 28 and peripheral support 30 are formed as a single unit from fiberglass-reinforced plastic (FRP). Peripheral support 30, in the form of first and second horizontal flanges 32 and 36 and first and second vertical flanges 40 and 44, is a continuous flange member integral to screen face 28 to provide dimensional stability of screen structure 20, to serve as a stiffening element, and to provide a convenient concealed mounting surface for screen structure 20. The FRP medium allows the passage of radio frequency signals, is non-conductive, non-magnetic, and resistant to degradation from environmental effects.

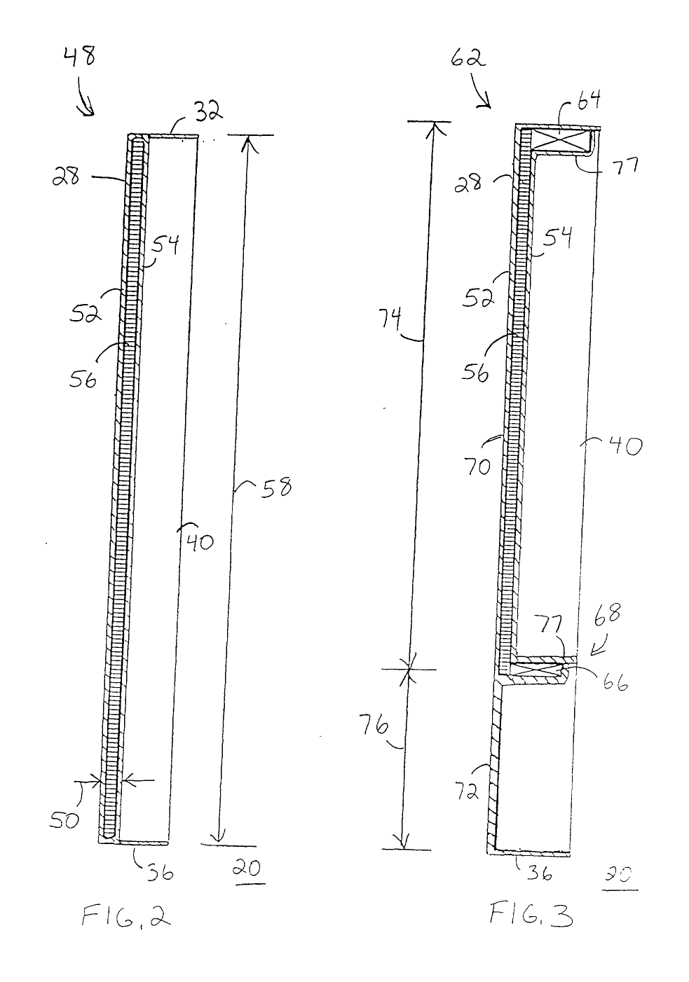

Referring to FIG. 2 in connection with FIG. 1, FIG. 2 shows a sectional side view of a first configuration 48 of antenna screen structure 20 (FIG. 1) along a section 2-2. Screen face 28 is supported at the periphery by peripheral support 30. The support at the periphery, in place of the traditionally used columns, beams, and other stiffeners within the propagation path of the radio frequency (RF) signals, is advantageous because the lower the mass between a transmitter and a receiver, the lower the signal attenuation and phase shift. Thus, the configuration of screen face 28 and peripheral support 30 of antenna screen structure 20 forms an RF transparent “window”, while still conforming to rigid structural requirements. Peripheral support 30 is anchored into the existing structure of building 26 at location 24.

One technique for making screen face 28 stiffer, while maintaining support of screen face 28 solely at the periphery, is to increase a thickness 50 of screen face 28. In the case of a solid FRP screen face (not shown), increasing thickness 50 causes screen face 28 to become less RF transparent. That is, attenuation of the radio frequency signals transmitted from and received by antenna 22 increases as thickness 50 of solid FRP increases. Accordingly, the present invention contemplates a solid FRP construct for screen face 28 of certain spans (i.e., height and width), in which the use of solid FRP may be acceptable without compromising the structural integrity of antenna screen structure, or the ability of the antenna screen structure to withstand predicted maximum wind loading without damage.

However, when the height or width of screen face 28 exceeds particular height and/or width criteria the present invention contemplates a cored construct in order to increase stiffness and maintain support of screen face 28 solely at the periphery. First configuration 48 of screen face 28 is of a cored laminate construct. In particular, screen face 28 includes a first FRP layer 52, a second FRP layer 54, and a stiffener core 56 interposed between first and second FRP layers 52 and 54, respectively.

In a preferred embodiment, stiffener core 56 is a stiffness element of screen face 28 formed of a thermoplastic honeycomb layer. Stiffener core 56 provides additional rigidity through a height 58 and a width 60 (see FIG. 1) of screen face 28, and causes very little attenuation of the RF signal. For clarity, stiffener core 56 is referred to hereinafter as thermoplastic honeycomb layer 56. However, it should be apparent to those skilled in the art that alternative materials may be employed as the stiffener core in place of thermoplastic honeycomb layer 56. For example, rigid foam or three-dimensional woven fiber materials may be used that cause little attenuation of the RF signal and provide rigidity.

In a preferred embodiment, first and second FRP layers 52 and 54 are each in the range of 0.09 to 0.12 inches thick, while thermoplastic honeycomb layer 56 is in the range of 0.5 to 2 inches thick. The cored construct enables spans of six feet between stiffening members.

Screen face 28 is shown as being flat for simplicity of illustration. However, screen face 28 may actually have molded-in details and reliefs that imitate the appearance of the surrounding structure, i.e., building 26. However, these details and reliefs are shallow compared to height 58 and width 60, so that screen face 28 may be evaluated as a flat plate.

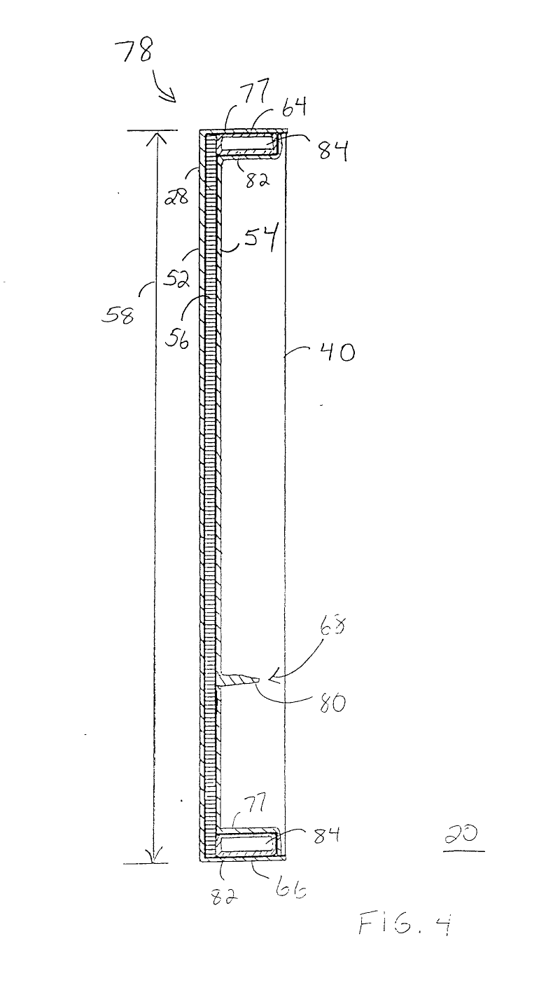

FIG. 3 shows a sectional side view of a second configuration 62 of antenna screen structure 20. When height 58 (FIG. 2) or width 60 (FIG. 1) exceeds certain practical limits for the cored construct of first configuration 48 (FIG. 2), stiffeners may be used to provide antenna screen structure 20 with sufficient structural integrity. Thus, second configuration 62 includes a first beam member 64, second horizontal flange 36, and a second beam member 66, each of which span width 60 (FIG. 1) of screen face 28.

First beam member 64 replaces first horizontal flange 32 (FIG. 2) of first configuration 48 (FIG. 2). In addition, second beam member 66 is a horizontal intermediate support member 68 that provides stiffness at an intermediate position along screen face 28. Horizontal intermediate support member 68 forms a border between an upper section 70 and a lower section 72 of screen face 28, and may be shifted vertically to adjust a height 74 of upper section 70 and a height 76 of lower section 72. First and second beam members 64 and 66, respectively, are shown as solid core beams and may be a number of sizes and shapes, fabricated from a laminated wood product, metal, or FRP.

In addition, a skin 77, formed from fiber reinforced plastic (FRP), encases first and second beam members 64 and 66 to form antenna screen structure 20 as a single unit. Peripheral support 30, in the form of first and second horizontal flanges 32 and 36 (FIG. 1), respectively, and first and second vertical flanges 40 and 44 (FIG. 1), respectively, provide some beam characteristics. However, a flange by itself may not be able to carry significant loads, unless the flange is fastened to another structurally capable member or an existing building. Accordingly, when antenna structure 20 is unsupported along its length, first and second beam members 64 and 66 may be incorporated into the flange material (i.e., skin 77) during manufacturing so that a separate beam need not be fastened to screen face 28.

As shown in FIG. 3, upper section 70 of configuration 62 is of a cored construct and forms a window through which RF signals propagate to and from receiving and transmitting elements (not shown) of antenna 22. More specifically, upper section 70 includes first and second FRP layers 52 and 54, respectively, and thermoplastic honeycomb layer 56. In contrast, the receiving and transmitting elements (not shown) of antenna 22 (FIG. 1) are not located behind lower section 72. As such, lower section 72 may be of a solid FRP construct for ease of construction, and materials and fabrication cost savings.

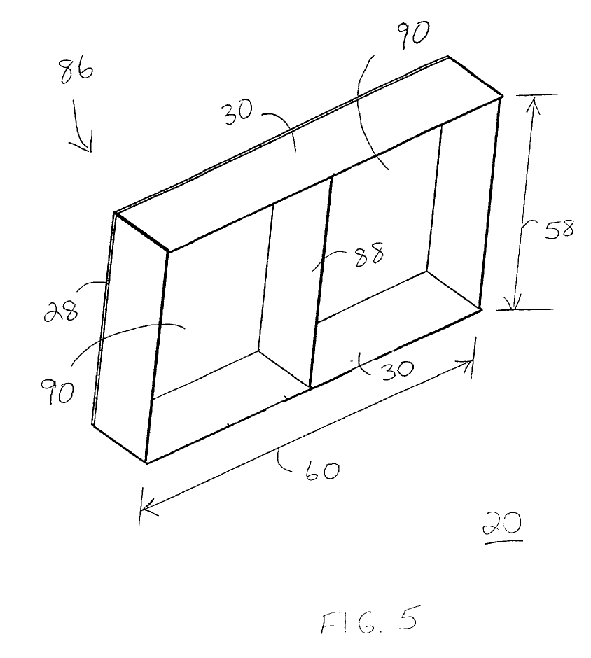

FIG. 4 shows a sectional side view of a third configuration 78 of antenna screen structure 20 (FIG. 1). Like second configuration 62, first beam member 64 replaces first horizontal flange 32 (FIG. 2) of first configuration 48 (FIG. 2). However, in third configuration 78, second beam member 66 replaces second horizontal flange 36 (FIGS. 2-3) of first and second configurations 48 and 62, respectively, and spans width 60 (FIG. 1) of screen face 28. Skin 77 encases first and second beam members 64 and 66 to form third configuration 78 of antenna screen structure 20 as a single unit.

Horizontal intermediate support member 68 of third configuration 78 is in the form of a solid FRP flange laminated to second FRP layer 54. Horizontal intermediate support member 68 may be utilized for providing additional stiffness to screen face 28 and/or as an antenna mount 80 for the attachment of cell site RF antenna 22 (FIG. 1). Like first configuration 48 (FIG. 2), screen face 28 of third configuration 74 also includes first and second FRP layers 52 and 54, respectively, and thermoplastic honeycomb layer 56 that provides stiffness through height 58 and width 60 (FIG. 1) of screen face 28.

First and second beam members 64 and 66 are box beams 82 exhibiting a rectangular cross section and having a hollow interior passage 84. Like the solid core composition of first and second beam members 64 and 66, discussed above, box beams 82 may be a number of sizes and shapes. In a preferred embodiment, box beams 82 may be fabricated from metal, FRP, or other composite materials. Box beams 82 may be optionally utilized for first and second beam members 64 and 66 to as a cost savings alternative and for simplicity.

FIG. 5 shows a perspective rear view of a vertical beam configuration 86 of antenna screen structure 20. When width 60 exceeds certain practical limits for the cored construct of first, second, and third configurations 48, 62, and 78, respectively, one or more vertical support members 88 may be used to provide antenna screen structure 20 with sufficient structural integrity.

Vertical intermediate support members 88, of which only one is shown, span height 58 of screen face 28 to form a border between separate sections 90 of screen face 28. Vertical intermediate support member 88 may be utilized to conceal a number of antennas 22 (FIG. 1), for example, a single antenna 22 may be concealed behind each section 90. Thus, each of sections 90 forms an RF transparent window through which RF signals propagate to and from a particular one of antennas 22. Vertical intermediate support member 88 is depicted as a solid FRP flange member. However, vertical intermediate support member 88 may alternatively be a beam member formed of wood, metal, or a composite material.

Peripheral support 30 of vertical beam configuration 86 may be a continuous flange member that resembles the form of first and second horizontal flanges 32 and 36, respectively, (FIG. 1) and first and second vertical flanges 40 and 44, respectively (FIG. 1). Peripheral support 30 of vertical beam configuration 78 may also include first and second beam members 64 and 66, respectively, as discussed in connection with second configuration 62 (FIG. 3). Vertical beam configuration 78 may further include first and second FRP layers 52 and 54, respectively, and thermoplastic honeycomb layer 56 shown in FIGS. 2-3.

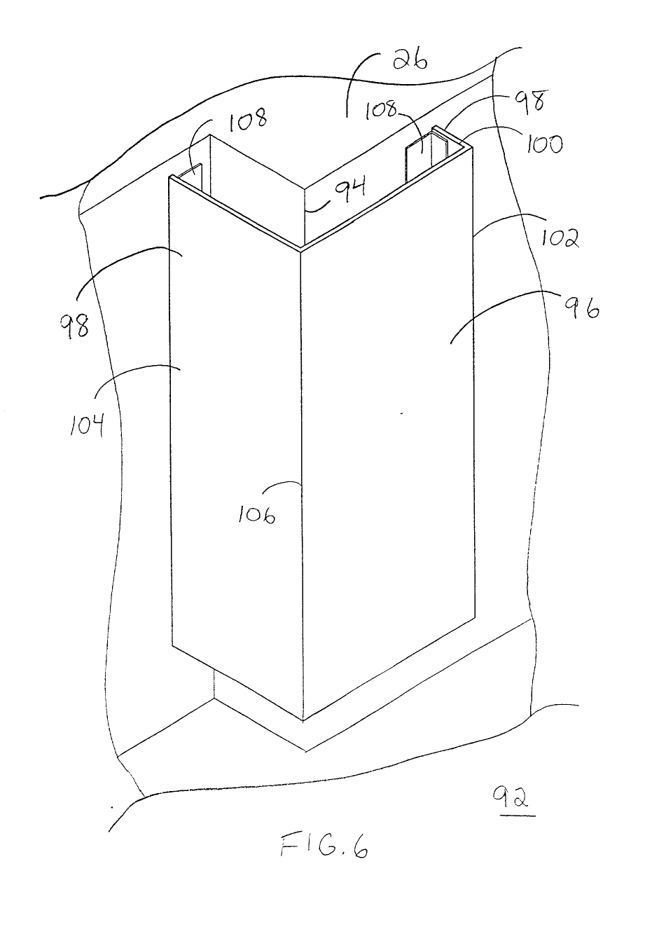

FIG. 6 shows a perspective view of a second antenna screen structure 92. Second antenna screen structure 92 is advantageously sized and shaped to fit about a corner 94 of building 26. Second antenna screen structure 92 includes a screen face 96 and a peripheral support 98. Cell site RF antenna 22 is concealed from view behind screen face 96. Screen face 96 may be solid FRP or the cored laminate construct of first and second FRP layers 52 and 54 and thermoplastic honeycomb layer 56 (FIG. 2-4) as discussed above.

Peripheral support 98 includes a first flange member 100 formed along a first side edge 102 of screen face 96, and a second flange member 104 formed along a second side edge 106 of screen face 94. Angle brackets 108 of steel or a composite material are used to secure second structure 92 to building 26. Alternatively, screen face 96 may extend around corner 94 to replace second flange member 104. In such a configuration, separate antennas may be concealed behind each portion of screen face 96 to provide communications for two sectors of the cell site.

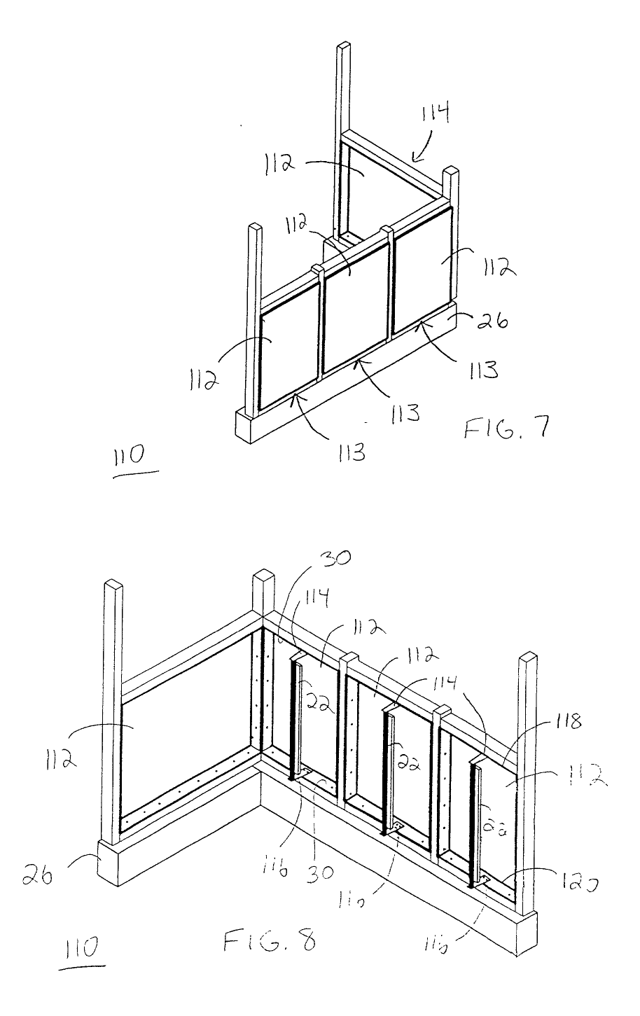

Referring to FIGS. 7-8, FIG. 7 shows a perspective front view of a third antenna screen structure 110 and FIG. 8 shows a perspective rear view of third antenna screen structure 110. Third antenna screen structure 110 includes a number of separate antenna screen substructures 112, each of which are configured to fit at separate specified locations 113, or openings, in the side of building 26. Substructures 112 are adaptations of antenna screen structure 20 (FIG. 1) and may include many of the features described in connection with FIGS. 1-6. Third antenna screen structure 110 advantageously conceals an array of cell site RF antennas 22, of which three are shown, which may be of varying sizes and shapes for several different systems.

Third antenna screen structure 110 further shows first and second mounting brackets 114 and 116, respectively, coupled to peripheral support 30 of substructures 112. For example, first mounting brackets 114 are coupled to peripheral support 30 proximate an upper edge 118 of some of screen faces 28 and second mounting brackets 116 are coupled to peripheral support 30 proximate a lower edge 120 of some of screen faces 28. First and second mounting brackets 114 and 116 are manufactured from FRP for strength, durability, and RF transparency, and are configured to retain cell site RF antennas 22.

FIG. 9 shows a perspective rear view of a fourth antenna screen structure 122. Fourth antenna screen structure 122 is a two-sided construction that is configured to attach to a parapet 124 on a corner 126 of building 26. Fourth antenna screen structure 122 advantageously conceals one of antennas 22 (FIG. 1) or an array of cell site RF antennas 22, of varying sizes and shapes for several different systems, which may be located on corner 126 of building 26.

Structure 122 includes first and second substructures 128 and 130, respectively. First substructure 128 includes a first RF transparent screen face 132 and a first peripheral support 134 integral to an edge 136 of first screen face 132. A first flange member 135 of first peripheral support 134 is formed along a lower portion 137 of edge 136. Similarly, second substructure 130 includes a second RF transparent screen face 138 and a second peripheral support 140 integral to an edge 142 of second screen face 138. A second flange member 139 of second peripheral support 140 is formed along a lower portion 141 of edge 142. Fourth antenna screen structure 122 further includes couplings 143, such as screws, configured for securing first and second flange members 135 and 139, respectively, to parapet 124. First and second substructures 128 and 130 are adaptations of antenna screen structure 20 (FIG. 1) and may include many of the features described in connection with FIGS. 1-6.

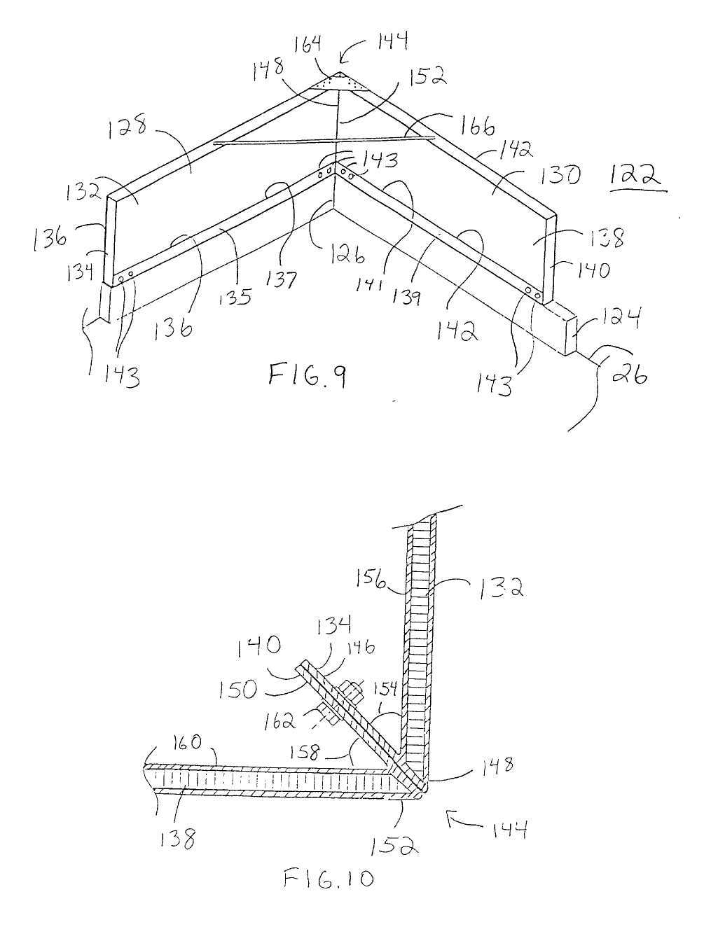

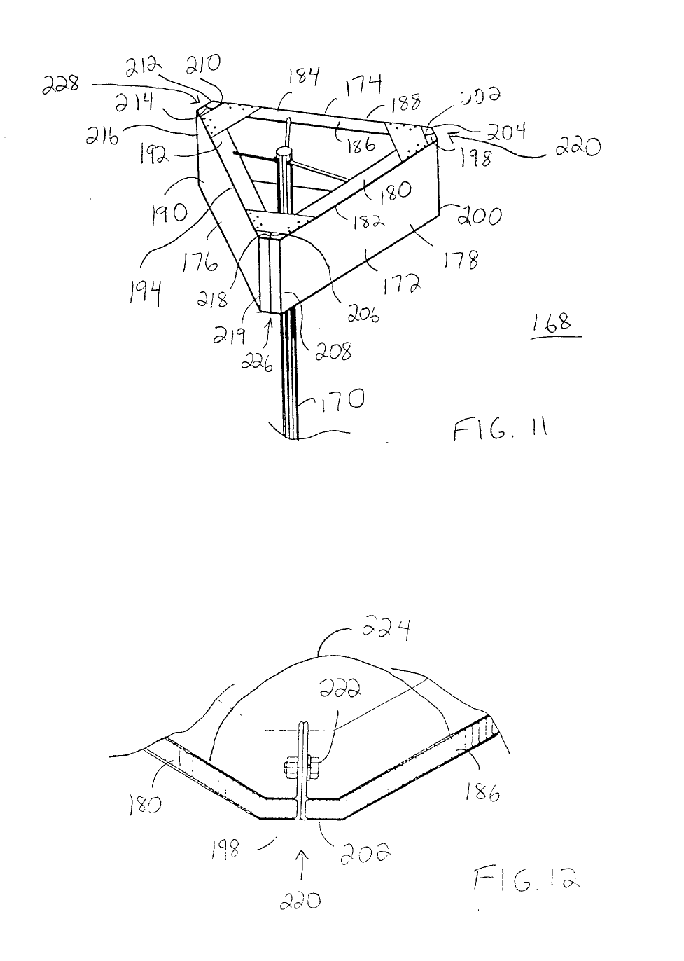

Referring to FIG. 10 in connection with FIG. 9, FIG. 10 shows a sectional top view of a flange joint 144 formed between first and second peripheral supports 134 and 140, respectively of first and second substructures 128 and 130. In particular, a first vertical flange member 146 of first peripheral support 134 is integral to a first side edge 148 of first screen face 132 and a second vertical flange member 150 of second peripheral support 140 is integral to a second side edge 152 of second screen face 138.

A first angle 154 between first vertical flange member 146 and a rear side 156 of first screen face 132 is less than ninety degrees. Likewise, a second angle 158 between second vertical flange member 150 and a rear side 160 of second screen face 138 is less than ninety degrees. For example, first and second angles 154 and 158, respectively, are approximately forty-five degrees. First and second vertical flange members 146 and 150, respectively, abut one another and are coupled using one or more fasteners 162, of which one is shown, to fit to the approximately ninety degree bend at corner 126.

Fourth antenna screen structure 122 may further include an optional FRP gusset 164 and/or an optional steel diagonal brace 166 to add further strength and stability at flange joint 144. In addition, or alternatively, angle brackets (not shown) may be coupled to first and second vertical flange members 146 and 150 to increase the strength of flange joint 144, especially at the locations where first and/or second beam members 64 and 66 (FIGS. 3-4) intersect first and second side edges 148 and 152, respectively, of first and second screen faces 132 and 138, respectively. The angle brackets may be manufactured from steel if they are located outside of the signal propagation path of RF signals transmitted from and received by antenna 22. Alternatively, the angle brackets may be manufactured from RF transparent FRP if they are located inside of or near the signal propagation path of the RF signals to reduce the deleterious effects of RF signal degradation through the angle brackets.

It should be understood that the flange joint between adjacent peripheral supports need not result in a ninety degree bend in the antenna screen structure. In alternative embodiments, the flange joint may result in a one hundred and twenty degree bend in a three-sided antenna screen structure or another desired angular bend. Alternatively, the flange joint may merely attach a first substructure to another substructure without resulting in any bend in the antenna screen structure.

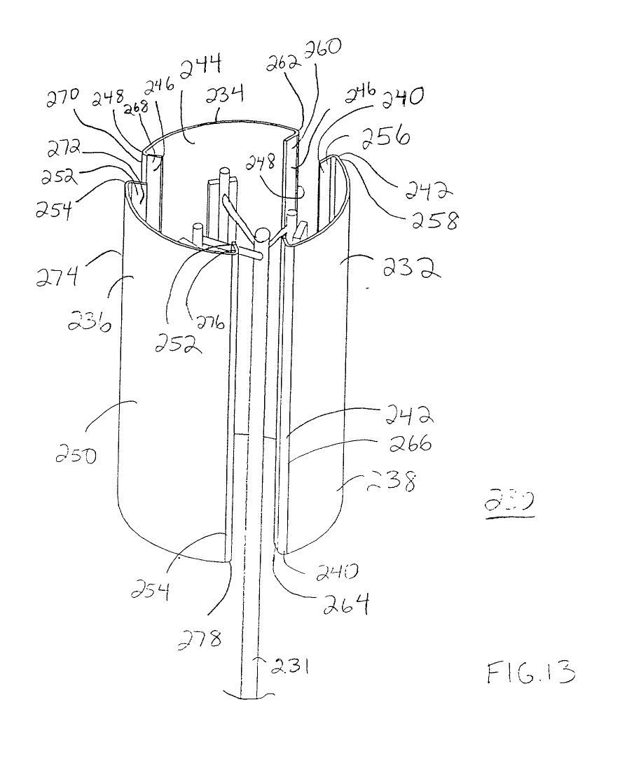

FIG. 11 shows a perspective view of a fifth antenna screen structure 168 having a triangular configuration. Fifth antenna screen structure 168 advantageously conceals one of antennas 22 (FIG. 1) or an array of cell site RF antennas 22, of varying sizes and shapes for several different systems, which may be mounted on a pole 170. Fifth antenna screen structure 168 includes first, second, and third substructures 172, 174, and 176, respectively. The construct of first, second, and third substructures 172, 174, and 176 advantageously enables access to one third of structure 168 at a time, thus simplifying the adjustment and calibration of antennas 22.

First substructure 172 includes a first RF transparent screen face 178 and a first peripheral support 180 integral to an edge 182 of first screen face 178. Similarly, second substructure 174 includes a second RF transparent screen face 184 and a second peripheral support 186 integral to an edge 188 of second screen face 184. Third substructure 176 includes a third RF transparent screen face 190 and a third peripheral support 192 integral to an edge 194 of third screen face 190. First, second, and third substructures 172, 174, and 176 are adaptations of antenna screen structure 20 (FIG. 1) and may include many of the features described in connection with FIGS. 1-6.

A first vertical flange member 198 of first peripheral support 180 is integral to a first side 200 of edge 182. Similarly, a second vertical flange member 202 of second peripheral support 184 is integral to a second side 204 of edge 188. In addition, a third vertical flange member 206 of first peripheral support 180 is integral to a third side 208 of edge 182. A fourth vertical flange member 210 of second peripheral support 186 is integral to a fourth side 212 of edge 188. Third peripheral support 192 of third substructure 176 includes a fifth vertical flange member 214 integral to a fifth side 216 of edge 194 and a sixth vertical flange member 218 integral to a sixth side 219 of edge 194.

Referring to FIG. 12 in connection with FIG. 11, FIG. 12 shows a sectional top view of a flange joint 220 formed between first vertical flange member 198 of first peripheral support 180 and second vertical flange member 202 of second peripheral support 186. First and second vertical flange members 198 and 202, respectively, abut one another and are coupled using one or more fasteners 222. An angle 224 formed between a rear surface of first screen face 178 and a rear surface of second screen face 184 is approximately one hundred and twenty degrees. A second flange joint 226 between third vertical flange member 206 and sixth vertical flange member 218 and a third flange joint 228 between fourth vertical flange member 210 and fifth vertical flange member 214 are configured similarly to establish the triangular configuration of fifth antenna screen structure 168.

FIG. 13 shows an exploded perspective view of a sixth antenna screen structure 230 having a cylindrical configuration. Like fifth structure 168 (FIG. 12), sixth antenna screen structure 230 also conceals one of antennas 22 (FIG. 1) or an array of cell site RF antennas 22, of varying sizes and shapes for several different systems, which may be mounted on a pole 231. In addition, like fifth antenna screen structure 168, sixth structure 230 is also a three element system of first, second, and third substructures 232, 234, and 236, respectively, which are adapted from antenna screen structure 20 (FIG. 1) and may include some of the features described in connection with FIGS. 1-6. The construct of first, second, and third substructures 232, 234, and 236 advantageously enables access to one third of structure 230 at a time, thus simplifying the adjustment and calibration of antennas 22.

First substructure 232 includes a first RF transparent screen face 238 and a first peripheral support 240 integral to an edge 242 of first screen face 238. Second substructure 234 includes a second RF transparent screen face 244 and a second peripheral support 246 integral to an edge 248 of second screen face 244. Third substructure 236 includes a third RF transparent screen face 250 and a third peripheral support 252 integral to an edge 254 of third screen face 250. First, second, and third screen faces 238, 244, and 250 are curved to achieve the cylindrical configuration of fifth antenna screen structure 230.

A first vertical flange member 256 of first peripheral support 240 is integral to a first side 258 of edge 242. Similarly, a second vertical flange member 260 of second peripheral support 246 is integral to a second side 262 of edge 248. In addition, a third vertical flange member 264 of first peripheral support 240 is integral to a third side 266 of edge 242. A fourth vertical flange member 268 of second peripheral support 246 is integral to a fourth side 270 of edge 248. Third peripheral support 252 of third substructure 236 includes a fifth vertical flange member 272 integral to a fifth side 274 of edge 254 and a sixth vertical flange member 276 integral to a sixth side 278 of edge 254.

First vertical flange member 256 is coupled to second vertical flange member 260. In addition, third vertical flange member 264 is coupled to sixth vertical flange member 276, and fourth vertical flange member 268 is coupled to fifth vertical flange member 272. The interconnection of first, second, and third substructures 232, 234, and 235 establishes the cylindrical configuration of sixth antenna screen structure 230.

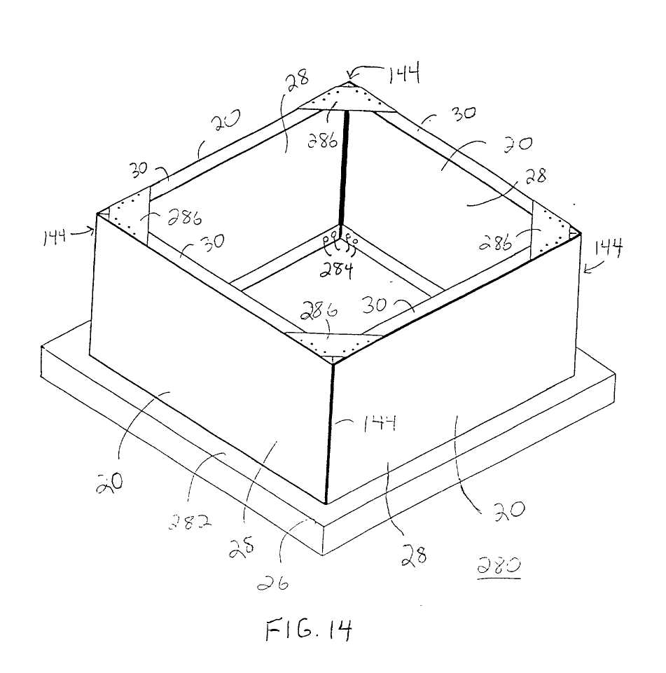

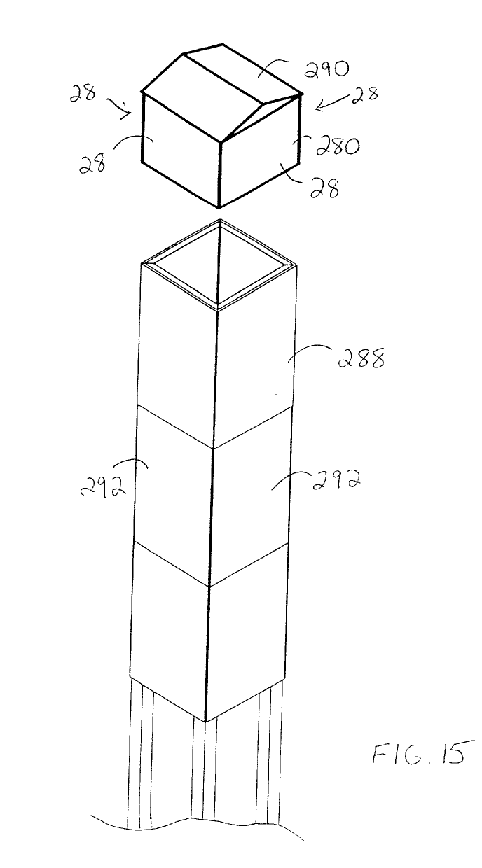

FIG. 14 shows a perspective view of a sixth antenna screen structure 280 having a box-shaped configuration. Sixth antenna screen structure 280 is an adaptation of antenna screen structure 20 and is configured to be mounted to a roof 282 of building 26. That is, fasteners 284 positioned at each corner of sixth antenna screen structure are utilized to secure sixth antenna screen structure 280 to roof 282. Sixth antenna screen structure 280 may be used to conceal one or more cell site RF antennas 22 (FIG. 1) from all sides.

Sixth antenna screen structure 280 is formed by coupling four of antenna screen structures 20 along peripheral supports 30 and may include many of the features described in connection with FIGS. 1-6. Thus, sixth antenna screen structure 280 includes four RF transparent screen faces 28. Peripheral supports 30 are integral to the edges of each screen face 28, as described in detail in connection with first antenna screen structure 20 (FIG. 1).

Referring momentarily to FIG. 10 in connection with FIG. 14, sixth antenna screen structure 280 includes four flange joints 144 formed by the vertical flange members, such as first and second vertical flange members 146 and 150, respectively, of each of peripheral supports 30. A description of flange joints 144 of sixth antenna screen structure 280 is not repeated herein for brevity. Suffice to say that each corner of sixth antenna screen structure 280 includes vertical flange members and the interconnection of the fourth screen faces 28 of structure 280 along the vertical flange members establishes the box-shaped configuration of structure 280. Corner gussets 286 may be used to provide additional strength at each corner of the box-shaped sixth antenna screen structure 280.

FIG. 15 shows a perspective view of box-shaped sixth antenna screen structure 280 mounted on a tower 288. Thus far, each antenna screen structure has been described as being secured to a building parapet, roof, or side, or being pole mounted. Alternatively, an antenna screen structure may be attached to the top of a pre-existing or new structure, such as tower 288. Sixth antenna screen structure 280 may be further disguised through the addition of a pitched roof 290 and by finishing each screen face 28 of structure 280 to match the color, texture, and so forth of an exterior surface 292 of tower 288.

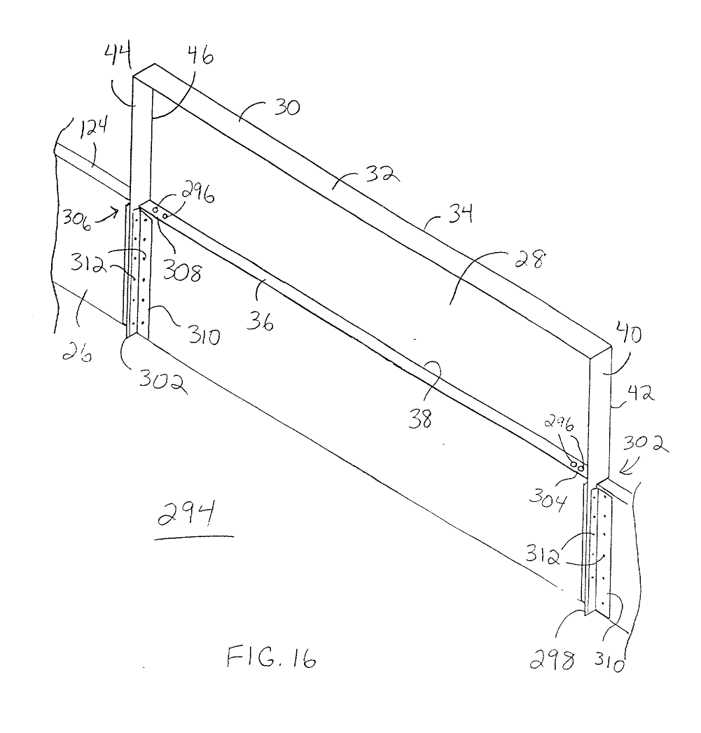

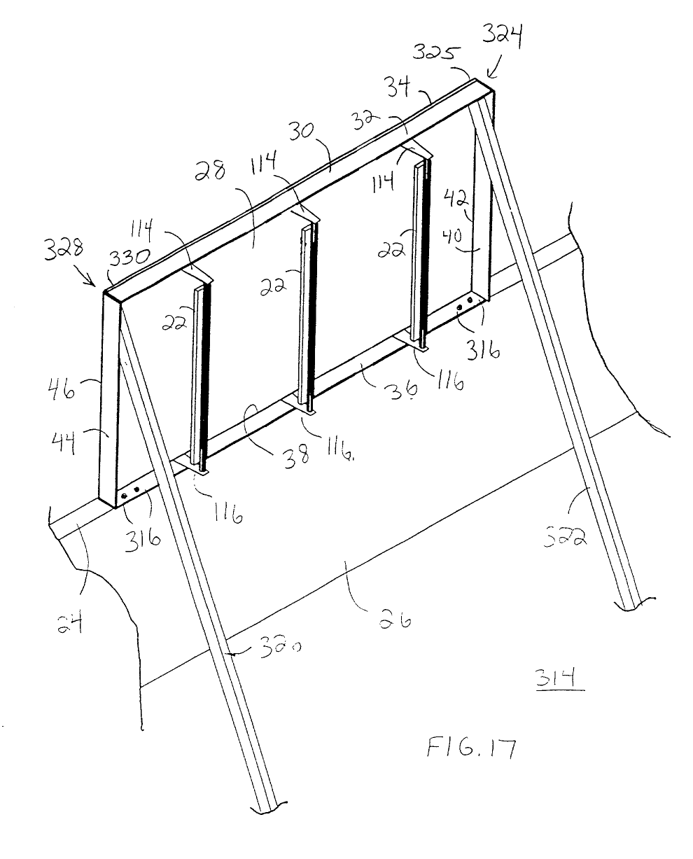

FIG. 16 shows a perspective rear view of a seventh antenna screen structure 294. Seventh antenna screen structure 294 is an adaptation of antenna screen structure 20 (FIG. 1) and may include many of the features described in connection with FIGS. 1-6. Seventh antenna screen structure 294 includes RF transparent screen face 28 and integral peripheral support 30. As shown, peripheral support 30 includes first horizontal flange 32 on upper edge 34 and second horizontal flange 36 on lower edge 38 of screen face 28. In addition, peripheral support 30 includes first vertical side flange 40 on first side edge 42 and second vertical flange 44 on second side edge 46 of screen face 28. Second horizontal flange 36 is configured to be coupled to parapet 124 of building 26 via fasteners 296.

First and second support legs 298 and 300 are integral to screen face 28 and peripheral support 30. More specifically, first support leg 298 is positioned at a first lower corner 302 3C of screen face 28, first lower corner 302 being defined by first side edge 42 and a first end 304 of lower edge 38.

Likewise, second support leg 300 is positioned at a second lower corner 306 of screen face 28, second lower corner 306 being defined by second side edge 46 and a second end 308 of lower edge 38.

First and second support legs 298 and 300 extend from first and second lower corners 302 and 306, respectively, and are configured to be coupled to building 26. For example, angle brackets 310 are attached to both first support leg 298 and parapet 124 using fasteners 312. Similarly, angle brackets 310 are attached to both second support leg 300 and parapet 124 using fasteners 312.

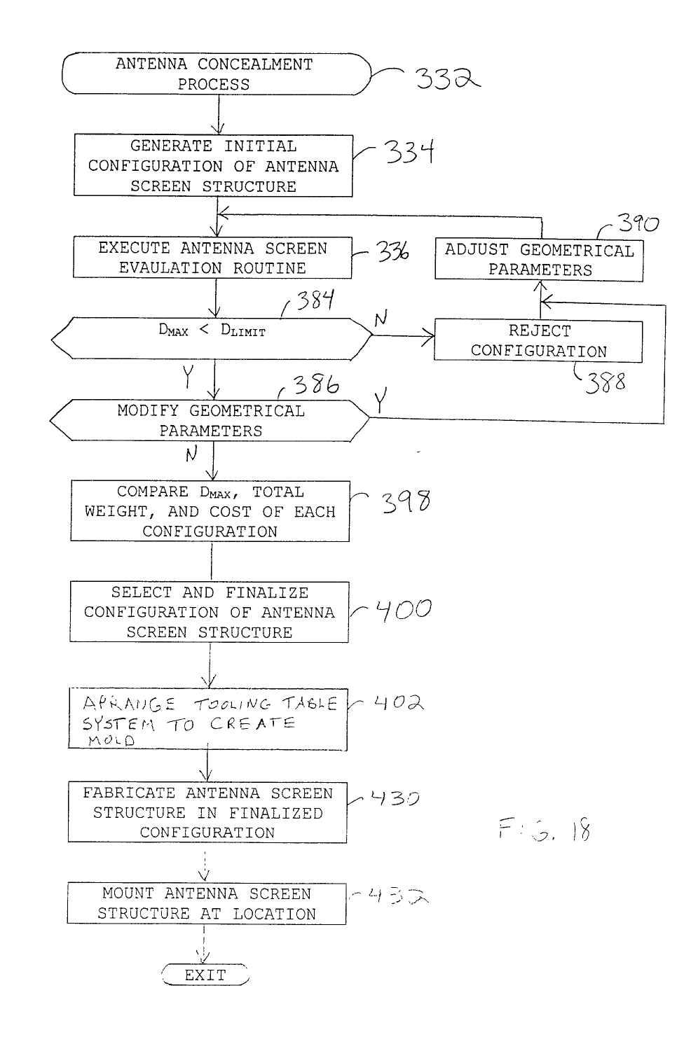

FIG. 17 shows a perspective rear view of an eighth exemplary antenna screen structure 314. Eighth antenna screen structure 314 is an adaptation of antenna screen structure 20 (FIG. 1) and may include many of the features described in connection with FIGS. 1-6. Eighth antenna screen structure 314 includes RF transparent screen face 28 and integral peripheral support 30. As shown, peripheral support 30 includes first horizontal flange 32 on upper edge 34 and second horizontal flange 36 on lower edge 38 of screen face 28. In addition, peripheral support 30 includes first vertical side flange 40 on first side edge 42 and second vertical flange 44 on second side edge 46 of screen face 28. Second horizontal flange 36 is configured to be coupled to parapet 124 of building 26 via fasteners 316.

Eighth antenna screen structure 314 further includes first and second mounting brackets 114 and 116, respectively onto which three cell site RF antennas 22 are secured. A first brace 322 is coupled at a first upper corner 324 of screen face 28, first upper corner 324 being defined by first side edge 42 and a first end 325 of upper edge 34. A second brace 326 is coupled to a second upper corner 328 of screen face 28, second upper corner 328 being defined by second side edge 46 and a second end 330 of upper edge 34. Each of first and second braces 322 and 326, respectively, extend from first and second upper corners 324 and 328, respectively, and are configured to couple to building 26.

Seventh antenna screen structure 294 (FIG. 16) and eighth antenna screen structure 314 advantageously conceal one of antennas 22 or an array of cell site RF antennas 22, of varying sizes and shapes for several different systems, which may be located on building 26. First and second support legs 298 and 300 (FIG. 16) of seventh structure 294 and first and second braces 322 and 326, respectively, provide a load transfer path for transferring forces due to wind loading to building 26.

Various configurations of antenna screen structures have been described in connection with FIGS. 1-17. The above-described configurations are not intended to be an all inclusive list of the possible antenna screen structures. Rather, the above configurations are an exemplary catalog of possible antenna screen structures. Other examples might include a three-sided structure with three screen faces, one of which is parapet mounted, and the other two faces being roof mounted, either with or without support legs. Alternatively, a single-sided, two-sided, three-sided, or box-shaped antenna screen structure may be configured to be attached to a raised platform structure, rather than to a parapet or to the rooftop.

The present invention efficiently evaluates a variety of proposed configurations of antenna screen structures, such as those described in connection with FIGS. 1-17, to characterize the structural integrity and assess the cost of a proposed antenna screen structure to determine the optimal antenna screen structure configuration (i.e. flanges, beams, cored, solid FRP, intermediate support members, and so forth) at the best cost. While nearly every cell site is unique, the present invention employs a fundamental arrangement of various “common” shapes, profiles, and sections. By using a small selection of different construction and detail types (elements) and a single unit construction technique, most antenna screen structures can be built by judicious arrangement and grouping of these elements.

FIG. 18 shows a flow chart of an antenna concealment process 332. Antenna concealment process 332 is performed to design, fabricate, and install antenna screen structures while balancing the varied and overlapping constraints of aesthetic effectiveness, structural reliability, RF transparency, quick turn-around time, and reasonable cost.

Process 332 begins with a task 334. Task 334 calls for generating an initial configuration of an antenna screen structure. At task 133, a proposed cell site location, antenna screen structure concept, and antenna placement criteria are studied. Study can entail visiting the proposed site and obtaining dimensions, such as height 58 (FIG. 1) and width 60 (FIG. 1), of an antenna screen structure and obtaining details regarding the existing structure. Other information that can be obtained at a site visit include, for example, surface finish texture and color, site accessibility issues for installation of the antenna screen structure, site preparation for the antenna screen structure, and visual and aesthetic issues.

For clarity in the present discussion, the result of task 334 is the generation of first configuration 48 (FIG. 2) of antenna screen structure 20 (FIGS. 1-2). Following generating task 334, a task 336 is performed. At task 336, an antenna screen evaluation routine is executed.

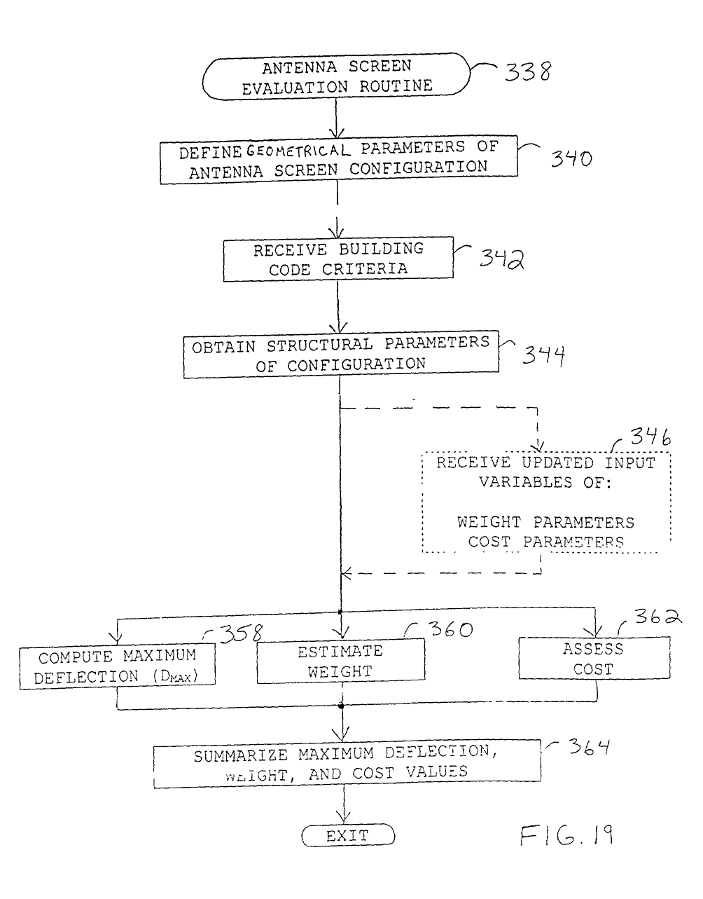

FIG. 19 shows a flow chart of an antenna screen evaluation routine 338 executed at task 336 of antenna concealment process 332. Antenna screen evaluation routine 338 is a computer-based method for evaluating a proposed configuration, such as first configuration 48, of an antenna screen structure generated at task 334 (FIG. 18) of antenna concealment process 332 (FIG. 18). Antenna screen evaluation routine 338 may be advantageously employed to readily perform a structural analysis of a proposed configuration that accounts for the inherent properties of the materials used to construct the antenna screen structures, described above.

Antenna screen evaluation routine 338 may be executed on a computing system (not shown) that is implemented utilizing conventional components. For example, the computing system includes a processor, in communication with an input element (such as a mouse, keyboard, etc.), an output element (monitor, printer, etc.), a computer-readable storage medium, and memory. The computer-readable storage medium may be a hard disk drive internal or external to the processor, a magnetic disk, compact disk, or any other volatile or non-volatile mass storage system readable by the processor. The memory is addressable storage space, accessible by the processor, which stores information or instructions for use.

Executable code for instructing the processor to evaluate a configuration of an antenna screen structure is in the form of antenna screen evaluation routine 338 and is recorded on the computer-readable storage medium. In a preferred embodiment, routine 338 was assembled using TK Solver, created by Universal Technical Systems, Inc., Rockford, Ill. TK Solver is a rule-based declarative programming environment for creating mathematical models and solving them multidirectionally. TK Solver simplifies math models into the form of systems of equations and relationships which saves development time, and supports familiar forms of mathematical modeling. Those skilled in the art will recognize that other mathematical modeling tools may be employed in the assembly of antenna screen evaluation routine 338.

Through TK solver, formulas, otherwise known as rules, are entered into a “Rule Sheet” in any order. The variables that the formulas contain are automatically posted to a “Variable Sheet.” The Variable Sheet has columns for input values and output values. A developer may then enter the desired input values, solve the model, and the output values of the model are provided. Throughout the following discussion, the formulas utilized in antenna screen evaluation routine 338 will be identified under the heading of “Rules” and the input and output values will be identified under the headings of “Input Variables” and “Output Variables”, respectively.

Antenna screen evaluation routine 338 begins with a task 340. At task 340, the geometrical parameters of first configuration 48 (FIG. 2) of antenna screen structure 20 (FIG. 1) are defined. The geometrical parameters of antenna screen structure 20 define the proposed size, shape, thickness, and supports for antenna screen structure 20. The geometrical parameters are defined as input and output variables using the rules pertaining to the geometrical parameters. At task 340, routine 338 receives the input variables, entered by a designer, that were determined when the initial configuration of antenna screen structure 20 is generated at task 334 (FIG. 18) of antenna concealment process 332 (FIG. 18). Task 340 then defines, or computes, the output variables of the geometrical parameters using the rules pertaining to the geometrical parameters as follows:

### Input Variables (Geometrical Parameters)

Dimensions:

x Height 58 (FIG. 1) of screen face 28, inches

a Width 60 (FIG. 1) of screen face 28, inches

Stiffness Element:

skin_t Thickness of each of first and second FRP layers 52 and 54, respectively (FIG. 2), inches

core_t Thickness of stiffener core, i.e., thermoplastic honeycomb layer 56 (FIG. 2), inches

Vertical Flanges:

Num_C_flg Quantity of first and second vertical flanges, 40 and 44, respectively

C_flg_wide Width of first and second vertical flanges, 40 and 44

C_flg_thk Thickness of first and second vertical flanges, 40 and 44

Horizontal Flanges:

Num_P_flg Quantity of first and second horizontal flanges, 32 and 36, respectively [When Num_P_flg is greater than 3 or when Num_P_flg is greater than 2 AND Num_Hbeams is at least 1, then computations include horizontal intermediate support member 68 configured to be a flange]

P_flg_wide Width of first and second horizontal flanges, 32 and 36, inches

P_flg_thk Thickness of first and second horizontal flanges, 32 and 36, inches

Horizontal Intermediate Support Members (beams):

NUM_Hbeams TOTAL quantity of horizontal beam members (i.e., first and second horizontal beam members 64 and 66

BM1 First beam member 64 (FIG.3)

i1b Outer width of BM1 (perpendicular to screen face 28))

i1d Outer height of BM1 (parallel to screen face 28)

i1b1 Inner width of BM1 (hollow tubes only)

i1d1 Inner height of BM1 (hollow tubes only)

BM2 Second beam member 66 (FIG. 3) is horizontal intermediate support member 68 (FIG. 3)

i2b Outer width of BM2 (perpendicular to screen face 28)

i2d Outer height of BM2 (parallel to screen face 28)

i2b1 Inner width of BM2 (hollow tubes only)

i2d1 Inner height of BM2 (hollow tubes only)

### Output Variables (Geometrical Parameters)

t Total thickness of screen face 28 (FIG. 1)

NUM_MIDbeams Quantity of horizontal intermediate support members 68 (FIG. 3) configured as beam members

b Equal to x when NUM_MIDbeams=0 or equal to height 74 (FIG. 3) of upper section 70 (FIG. 3) when NUM_MIDbeams=1

### Rules (Geometrical Parameters for Cored Screen Face 28 and Second Horizontal Flange 36 Attached to Substrate)

t=((skin_t*2)+core_t ;Total thickness of screen face 28

IF NUM_Hbeams=1 THEN NUM_MIDbeams=0; quantity of horizontal intermediate support members 68

x=b

IF NUM_Hbeams=2 THEN NUM_MIDbeams=1; quantity of horizontal intermediate support members 68, therefore x≠b

IF x≠b THEN x=(b+b2) ELSE b2=0; x is total height, b is height 74 of upper section 70, and b2 is height 76 of lower section 72

Following task 340, a task 342 is performed. At task 342, routine 108 receives the building-code criteria pertinent to location 24. The building code criteria is provided through local and/or regional Uniform Building Code (UBC) standards that regulate and control the design, construction, quality of materials, use, occupancy, location, and maintenance of all buildings and structures within a jurisdiction.

The most significant loads imposed on antenna screen structure 20 are the result of wind forces. Using the UBC standard, wind forces typically range from twenty-two to thirty-five pounds per square foot. A “standard” seventy mile-per-hour wind imposes approximately 12.7 psf. However, the UBC standard generally includes multipliers for site conditions and elevation that raise the wind load values. The building code criteria is defined as input and output variables using the rules pertaining to the building code criteria as follows:

### Input Variables (Building Code Criteria)

psf_BASE Baseline wind loading value

I_factor Importance factor multiplier

E_factor Elevation factor multiplier

SITE_factor Site coefficient multiplier

### Output Variables (Building Code Criteria)

psf Overall wind loading, lb/ft²

q Wind loading distributed on screen face 28, psi

TOT_load Total wind load value applied to screen face, lb

### Rules (Building Code Criteria)

psf=(psf_BASE*I_factor*E_factor*SITE_factor)

q=(psf/144) ;loading in psi

TOT_load=(q*a*x) ;total wind load

Following task 342, a task 344 is performed. At task 344, routine 338 obtains the structural parameters of first configuration. Many systems require two fundamental criteria to be determined of any member. These two fundamental criteria are allowable stress and allowable deflection. In a preferred embodiment, antenna screen structure is fabricated in fiberglass-reinforced plastic (FRP). FRP has a very high level of allowable stress relative to stiffness. Consequently, a design that accommodates allowable deflection also accommodates allowable stress. However, stress may optionally be computed through manual processes at concentrated load points, such as fastener locations.

The structural parameters are obtained through known and extrapolated properties and characterize the strength of screen face 28, and first and second beam members 64 and 66. The structural parameters include, for example, the allowable deflection ratio of first and second beam members 64 and 66 and horizontal intermediate support member 68, and the allowable deflection ratio of screen face 28. Other structural parameters include the modulus of elasticity of screen face 28, or upper section 70 (FIG. 3) of screen face 28, and the modulus of elasticity of first and second beam members 64 and 66 and horizontal intermediate support member 68. The allowable deflection ratio of a member is a value to which the ratio between the span length of the member and the maximum deflection for the member is limited. The allowable deflection ratio depends in part upon member shape, member function as a structural component, and the type of loading. The modulus of elasticity of a member is the stress per unit elastic strain, expressed as a ratio between the stress placed on a material and the strain. That is, the modulus of elasticity is a measure of the stiffness of a material. The structural parameters are defined as input and output variables using the rules pertaining to the structural parameters as follows:

### Input Variables (Structural Parameters)

L1 Allowable deflection ratio for horizontal beams, i.e., first and second beam members 64 and 66

L2 Allowable deflection ratio for screen face 28

E1 Modulus of elasticity for screen face 28

### Output Variables (Structural Parameters)

E_BM1 Modulus of elasticity for first beam member 64

E_BM2 Modulus of elasticity for second beam member 66

### Rules (Structural Parameters)

IF BM1=1 THEN E BM1=2.9E7 ELSE E_BM1=2.1E6 ;1 is a hollow rectangular beam type, 0 is a solid beam type

IF BM2=1 THEN E_BM2=2.9E7 ELSE E_BM2=2.1E6 ;1 is a hollow rectangular beam type, 0 is a solid beam type

The modulus of elasticity (E1) for screen face 28 is extrapolated by treating screen face 28 as a beam and using the formula for deflection, γ, from Table 3, case 1c, of Roark's Formulas for Stress and Strain, 5^{th} edition, 1975, by Warren C. Young as follows:

$$γ = \frac{{P ( L )}^{3}}{48 ( E ) ( I )}$$

therefore,

$$E = \frac{{P ( L )}^{3}}{48 ( γ ) ( I )}$$

where: P=applied load=10 lb

L=length=24 in

γ=maximum deflection=0.02448 in

I=moment of inertia=0.465 in⁴

and: E1=253,000 psi

With regard to first and second beam members 64 and 66, respectively, standard beam theory applies. Stress and deflection are a function of the applied loading per inch, the span, the modulus of elasticity, and the cross-sectional moment of inertia. The modulus of elasticity (E_BM1 and E_BM2) for each of first and second beam members 64 and 66, respectively, is determined in response to a composition of first and second beam members 64 and 66. For example, a beam formed from a laminated wood product exhibits a modulus of elasticity specific to that product, while a steel beam has a different modulus of elasticity specific to steel.

Following task 344, an optional task 346 may be performed, as denoted by dashed lines. Alternatively, program control may proceed to concurrent tasks 358, 360, and 362, discussed below. Optional task 346 detects the receipt of updated input variables of weight parameters and cost parameters, discussed below. Through the implementation of antenna screen evaluation routine 338 using the TK Solver mathematical modeling tool, all input variables may be adjusted. In a preferred embodiment, the input variables pertaining to material weight and cost are set to pre-determined default values. These pre-determined default values are utilized by routine 338 to determine a total weight and a total cost of a proposed antenna screen structure. However, these pre-determined default values of the input variables may be adjusted by the designer to accommodate different material characteristics and to accommodate changing costs in materials, processes, and so forth.

Exemplary pre-determined weight parameters are as follows:

### Input Variables (Pre-Determined Weight Parameters)

core_wt Weight of thermoplastic honeycomb layer 56 per square foot, lb/ft²

FRP_density Density of fiberglass-reinforced plastic, lb/ft³

BM1_lam_thk BM1 FRP laminate thickness, inches

BM1_lam_thk BM2 FRP laminate thickness, inches

Finish_thk Thickness of applied finish, inches Exemplary pre-determined cost parameters are as follows:

### Input Variables (Pre-Determined Cost Parameters)

FR_adder Adder for FR resin, $/lb

FRP_top_skin_cst_lb Cost per pound for first and second FRP layers 52 and 54, $/lb

core_cost_ft Cost of thermoplastic honeycomb layer 56, $/ft²

core_bond_cost_ft Cost to bond first and second FRP layers 52 and 54 to thermoplastic honeycomb layer 56, $/ft²

beam_lam Cost to laminate beams, $/lb

steel_cst_lb Cost for steel beam members, $/lb

wood_cst_lb Cost for wood beams, $/lb

stl_add “Adder” for EACH steel beam fab cost, $

wd_add “Adder” for EACH wood beam fab cost, $

C_flg cst_lb Cost to fabricate first and second vertical flanges 40 and 44, $/lb

P_flg_cst_lb Cost to fabricate first and second horizontal flanges 32 and 36, $/lb

Finish_cost Cost of texture finish, $/ft²

DETAILcost DETAILING costs, $/ft²

DEScost Design Cost, $

MOLDcost Mold costs, $

SHIPcost Shipping/packaging costs, $

OTHERcosts Other costs, $

NUM_corners Quantity of field-joints

corner_adder Adder for field-joint corner accommodations, $

At optional task 346, the received weight and cost parameters are entered in the “Variables Sheet.” Although, optional task 346 is described in connection with the execution of routine 388, it should be understood that input variables for weight and cost may be adjusted in the “Variables Sheet” at any time, not necessarily in connection with the execution of routine 338. Following task 344 or optional task 346 program control proceeds to concurrent tasks 358, 360, and 362.

Task 358 computes a maximum deflection value for the proposed configuration of the antenna screen structure in response to the geometrical parameters defined at task 340, the building code criteria received at task 342, and the structural parameters obtained at task 344. Similarly, task 360 estimates a total weight value for the proposed configuration, and task 362 assesses a total cost for the proposed configuration in response to the geometrical parameters defined at task 340, the building code criteria received at task 342, and the structural parameters obtained at task 344, as well as the pre-determined weight parameters, and pre-determined cost parameters. Tasks 358, 360, and 362 are interrelated and concurrent operations that are efficiently executed through the multidirectional capability of the TK solver mathematical modeling tool. For clarity of description, each of tasks 358, 360, and 362 are individually discussed below.

Task 358 computes structural conclusions of the proposed antenna screen configuration as follows:

### Output Variables (Structural Conclusions)

Dlimit2 Deflection limit of screen face 28 or upper section 70, DLIM(upper)

DEFplate Maximum deflection at center of screen face 28 or upper section 70, D_{MAX(upper)}

Dlimit3 Deflection limit of lower section 72, D_{LIM(lower)}

DEF1plate Deflection at center of lower section 72, D_{MAX (lower)}

Dlimit1 Deflection limit of beam members, D_{LIM(beam)}

DEFbm1 Deflection of first beam member 64, D_{MAX(upper}_{_{—}}_{beam)}

DEFbm2 Deflection of second beam member 66, D_{MAX(lower}_{_{—}}_{beam)}

I1 Moment of Inertia of first beam member 64, in⁴

I2 Moment of Inertia of second beam member 66, in⁴

A Alpha per Roark for upper section 70

wtot Wind load in pounds per inch-along horizontal length, lbs

wtot1 Wind load on first beam member 64, lbs/in

wtot2 Wind load on second beam member 66, lbs/in

### Rules (Structural Conclusions)

;MAXIMUM DEFLECTION VALUES OF SCREEN FACE 28, I.E. WIND LOADING:

DEFplate=((A*q*b⁴)/(E1*t³)) ;D_{MAX(upper}_{_{—}}_{section)}

IF NUM_Hbeams=2 THEN DEF1plate=((A*q*b2⁴)/(E1*t³)) ELSE DEF1plate=0 ;D_{mAx(lower}_section)

;ALPHA Values for A, case 1, upper screen section cored construct

IF and ((a/b)>0, (a/b)<=1.1) THEN A=0.0138

IF and ((a/b)>1.1, (a/b)<=1.3) THEN A=0.0188

IF and ((a/b)>1.3, (a/b)<=1.5) THEN A=0.0226

IF and ((a/b)>1.5, (a/b)<=1.7) THEN A=0.0251

IF and ((a/b)>1.7, (a/b)<=1.9) THEN A=0.0267

IF and ((a/b)>1.9, (a/b)<=2.1) THEN A=0.0277

IF and ((a/b)>2.1, (a/b)<=20) THEN A=0.0284

;MAXIMUM DEFLECTION VALUES OF BEAM MEMBERS, I.E. WIND LOADING

wtot=(q*x) ; psi*total height

wtot1=((q*(b/2)))

IF x≠b THEN wtot2=(wtot1+(((b2/2)*q))) ELSE wtot2=0

IF BM1=1 THEN I1=(((i1d*i1b³)−i1d1*i1b1³))/12 ELSE I1=((i1d+BM1_lam_thk)*((i1b+(BM1_lam_thk*2))³)/12)

IF BM2=1 THEN I2=(((i2d*i2b³)−i2d1*i2b1³))/12 ELSE I1=((i2d+BM2_lam_thk)*((i2b+(BM2_lam_thk*2))³)/12)

IF NUM_Hbeams=1 THEN DEFbm1=((2*wtot1*(a⁴))/(384*E_BM1*I1)) ELSE DEFbm1=0 ;D_{MAx(upper}_{_{—}}beam)

IF NUM_Hbeams=2 THEN DEFbm2=((2*wtot2*(a⁴))/(384*E_BM2*I2)) ELSE DEFbm2=0 ; D_{MAX(lower}_{_{—}}_{beam)}

;DEFLECTION LIMITS

Dlimit1=(a/L1) ;deflection limits, beam members, D_{LIM(beam)}

Dlimit2=(b/L2) ;deflection limit, upper section 70, D_{LIM(upper)}

Dlimit3=(b2/L2 ;deflection limit, lower section 72, D_{LIM(lower)}

The values computed through the execution of task 358 include maximum deflection values (DmAx) and deflection limit values (DLIM) for a proposed configuration of an antenna screen structure.

Task 360 estimates weight conclusions of the proposed antenna screen configuration as follows:

### Output Variables (Weight Conclusions)

Panel_WT Estimated weight of antenna screen structure, lb

Top_FRP_wt Weight of first and second FRP layers 52 and 54

Face_wt Total weight of screen face 28, lb

Atotal Total surface area of screen face 28, ft²

BM1_wt Weight of first beam member 64, lb

BM2_wt Weight of second beam member 66, lb

TOT_BM_wt Total weight of all beam members

BM1_lam_wt Laminate weight of first beam member 64, lb

BM2_lam_wt Laminate weight of second beam member 66, lb

TOT_BM_lam_wt Total weight of laminate, lb

Beam_wt Total weight of beam members and laminate, lb

C_flg_wt Weight of first and second vertical flanges 40 and 44, lb

P_flg_wt Weight of first and second horizontal flanges 32 and 36, lb

### Rules (Weight Conclusions)

;WEIGHT ESTIMATE OF ANTENNA SCREEN STRUCTURE

Panel_WT=((Face_wt+Beam_wt+Finish_wt+C_flg_wt+P_flg_wt)*1.1)

;WEIGHT OF SCREEN FACE 28

Face_wt=((Top_FRP_wt)+(core_wt+Atotal)

Top_FRP_wt=((a*x*(2*skin_t)FRP_density))

Atotal=((a*x)/144)

;WEIGHT OF BEAM MEMBERS

IF BM1=1 THEN BM1_wt=(((i1b*i1d)−(i1b1*i1d1))*a*0.284)

ELSE BM1_wt=(i1b*i1d*a*0.03)

IF BM2=1 THEN BM2_wt=(((i2b*i2d)−(i2b1*i2d1))*a*0.284)

ELSE BM2_wt=(i2b*i2d*a*0.03)

IF NUM_Hbeams=0 THEN TOT_BM_wt=0

IF NUM_Hbeams=1 THEN TOT_BM_wt=BM1_wt

IF NUM_Hbeams=2 THEN TOT_BM_wt=(BM1_wt+BM2_wt)

;WEIGHT OF LAMINATE BONDING ON BEAM MEMBERS

BM1_lam_wt=((((2*i1b)+(5*ild))*BM1_lam_thk*FRP_density)*a) BM1_lam_wt=((((2*i2b)+(5*i2d))*BM1_lam_thk*FRP_density)*a)

IF NUM_Hbeams=0 THEN TOT_BM_lam_wt=0

IF NUM_Hbeams=1 THEN TOT_BM_lam_wt=BM1_lam_wt

IF NUM_NHbeams=2 THEN TOT_BM_lam_wt=(BM1_lam_wt+BM2_lam_wt)

;TOTAL WEIGHT OF BEAM MEMBERS AND LAMINATE

IF NUM_Hbeams=0 THEN Beam_wt=0

ELSE Beam_wt=(TOT_BM_wt+TOT_BM_lam_wt)

;WEIGHT OF FINISH TEXTURE

Finish_wt=((Atotal*144)*Finish_thk*FRp_density)

;WEIGHT OF FIRST AND SECOND VERTICAL FLANGES 40 AND 44

C_flg_wt=(C_flg_wide*x*Num_C_flg*C_flg_thk*FRP_density)

;WEIGHT OF FIRST AND SECOND HORIZONTAL FLANGES 32 AND 26

p_flg_wt=(p_flg_wide*a*Num_P_flg*P_flg_thk*FRP_density)

The values estimated through the execution of task 360 include a total estimated weight and component weights for a proposed configuration of an antenna screen structure.

Task 362 assesses cost conclusions of the proposed antenna screen configuration as follows:

### Output Variables (Cost Conclusions)

TOT_cost Total cost of antenna screen structure

FACEcost Cost to laminate screen face 28

TOT_BM_cst Total cost to supply beam members

BEAMfrp_cost Total cost to apply FRP to beams

FINISHcost Cost to finish screen face 28

DETAIL_totcost Cost for detail work on screen face 28

C_flg_tot Total cost of first and second vertical flanges 40 and 44 and setup

P_flg_tot Total cost of first and second horizontal flanges 32 and 36 and setup

MISCcost Total misc. costs (design, mold, shipping)

Cost_foot Cost per foot

BM_cstl Cost for first beam member 64

BM_cst2 Cost for second beam member 66

Top_face_cost Cost for screen face 28

C_flg_cost Cost for first and second vertical flanges 40 and 44

C_flg_setup Setup cost for first and second vertical flanges 40 and 44

P_flg_cost Cost for first and second horizontal flanges 32 and 36

P_flg_setup Setup cost for first and second horizontal flanges 32 and 36

Field_corner_cst Cost for field joints

### Rules (Cost Conclusions)

;TOTAL COST OF ANTENNA SCREEN STRUCTURE

TOT_cost=(FACEcost+BEAMfrp_cost+TOT_BMcst+FINISHcost+DETAI L_totcost_MISCcost+C_flg_tot+P_flg_tot+Field_corner_cost)

;TOTAL COST OF ANTENNA SCREEN STRUCTURE PER SQUARE FOOT COST_foot=(TOT_cost/Atotal)

;COST OF SCREEN FACE 28

tot_core_cst=(((a*x)/144)*((core_cost_ft+Core_bond_cost_ft))+100)

Top_face_cst=((Top_FRP_wt*FRP_top_skin_cst_lb))

FACEcost=((Top_face_cst+tot_core_cst))

;COST TO FABRICATE BEAM STRUCTURE

IF BM1=1 THEN BM_cst1=((BM1_wt*steel_cst_lb)+stl_add)

ELSE BM_cst1=(BM1_wt*wood_cst_lb)+wd_add

IF BM2=1 THEN BM_cst2=((BM2_wt*steel_cst_lb)+stl_add)

ELSE BM_cst2=(BM2_wt*wood_cst_lb)+wd_add

IF NUM_Hbeams=0 THEN TOT_BM_cst=0

IF NUM_Hbeams=1 THEN TOT_BM_cst=BMN_cst1

IF NUM_Hbeams=2 THEN TOT_BM_cst=(BM_cst1+BM_cst2)

IF NUM_Hbeams=0 THEN BEAMfrp_cost=0

ELSE BEAMfrp_cost=(beam_lam_cost_lb*TOT_BM_lam_wt)

;COST TO FINISH SCREEN FACE 28

FINISHcost=(140+(Atotal*finish_cost_ft)(Finish_wt*1.5))

;COST TO PERFORM DETAIL WORK ON SCREEN FACE 28

DETAIL_totcost=(Atotal*DETAILcost)

;MISCELLANEOUS COSTS

MISCcost=(DEScost+MOLDcost+SHIPcost+OTHERcost)

;COST FOR FIRST AND SECOND VERTICAL FLANGES 40 AND 44

C_flg_cost=(C_flg_wt*C_flg_cst_lb)

C_flg_tot=(C_flg_cost+C_flg_setup)

IF C_flg_cost>0 THEN

C_flg_setup=((((x/12)*8)+100)*Num_C_flg) ELSE

C_flg_setup=0

;COST FOR FIRST AND SECOND HORIZONTAL FLANGES 32 AND 36

P_flg_cost=(P_flg_wt*P_flg_cst_lb)

P_flg_tot=(P_flg_cost+P_flg_setup)

IF P_flg_cost>0 THEN

P_flg_setup=((((a/12)*5)+40)*Num_P_flg) ELSE

P_flg_setup=0

;COST FOR FIELD JOINTS

Field_corner_cst=(NUM_corners*corner_adder)

The values assessed through the execution of task 362 include a total cost and a cost breakdown for a proposed configuration of an antenna screen structure. Following concurrent tasks 358, 360, and 362, program control proceeds to a task 364.

At task 364, the maximum deflection, weight, and cost values are summarized for comparison.

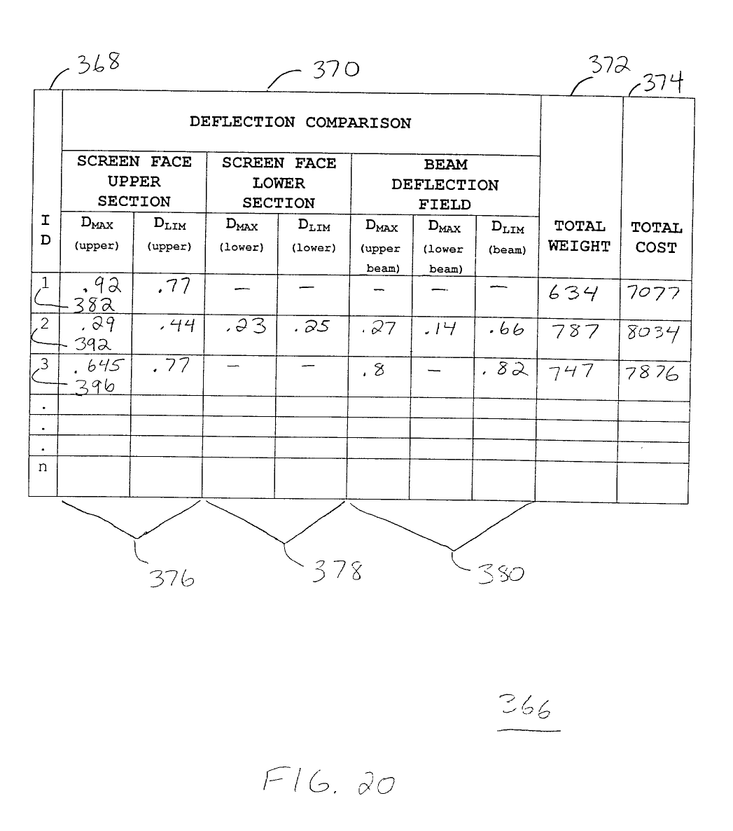

Referring to FIG. 20 in connection with task 364, FIG. 20 shows an exemplary table 366 of summary values generated through the execution of antenna screen evaluation routine 338. Table 366 includes a configuration identifier field 368, a deflection comparison field 370, a total weight field 372, and a total cost field 374. Deflection comparison field 370 is divided into sub-fields corresponding to an upper section deflection field 376, a lower section deflection field 378, and a beam deflection field 380.

Exemplary table 366 is provided for illustrative purposes. Those skilled in the art will recognize that table 366 may take many forms. Moreover, those skilled in the art will recognize that the information summarized in table 366 is also presented in the “Output Variables” column generated through the execution of routine 338 (FIG. 19), as implemented through TK Solver, and need not be compiled in a separate table.

During an exemplary execution of routine 338, first configuration 48 (FIG. 2) was evaluated. First configuration 48 is identified by a first identifier 382, labeled “1”, in configuration identifier field 368 and deflection, weight, and cost values are summarized in table 366 in association with first identifier 382. For example, in upper section deflection field 376 for first configuration 48, D_{MAX(upper)} is paired with D_{LIM(upper)}. Similarly, in lower section deflection field 378 for first configuration, D_{MAX(lower)} is paired with D_{LIM(lower)}. In beam deflection field 380 for first configuration 48, D_{MAX(upper}_{_{—}}_{beam)} and D_{MAX(lower}_{_{—}}_{beam)} are grouped with D_{LIM(beam)}.

With reference back to process 332 (FIG. 18) and routine 338 (FIG. 19), following summary task 364, antenna screen evaluation routine 338 exits and process control returns to a query task 384 of antenna concealment process 332. Query task 384 compares the maximum deflection values from wind loading, D_{MAX}, to the deflection limit values, D_{LIM}. When query task 384 determines that all of the maximum deflection values, D_{MAX} from wind loading are less than or equal to the deflection limit values, D_{LIM}, process 332 proceeds to a query task 386 (discussed below). An affirmative response to query task 384 indicates that a structural integrity of the proposed configuration of antenna screen structure 20 is sufficient to withstand wind loading at a proposed cell site location, for example, location 24 (FIG. 1)

However, when query task 384 determines that any of the maximum deflection values, D_{MAX} from wind loading are greater than the deflection limit values, D_{LIM}, process 332 proceeds to a task 388. Thus, a negative response to query task 384 indicates that a structural integrity of the proposed configuration of antenna screen structure 20 is insufficient to withstand wind loading at a proposed cell site location, for example, location 24 (FIG. 1)

Referring again to table 366 (FIG. 20) in connection with query task 384, each of upper section, lower section, and beam deflection fields 376, 378, and 380 associated with first identifier 382 are examined. Since first configuration 48 (FIG. 2) does not have first and second beam members, nor a horizontal intermediate beam member, lower section deflection field 378 and beam deflection field 380 are disregarded. As such, only D_{mAX(upper)} and D_{LIM(upper)} in upper section deflection field 146 are presented. In addition, a total weight of 634 lb is summarized in total weight field 372, and a total cost of $7077.00 is summarized in total cost field 374. As shown, D_{MAX(upper)} is greater than D_{LIM(upper)} and program control proceeds to task 388.

At task 388, the proposed configuration, i.e., first configuration 48, is rejected because D_{MAX(upper)} reveals that first configuration 48 has insufficient structural integrity to withstand wind loading at location 24. Following task 388, process 332 proceeds to a task 390.

At task 390, the geometrical parameters of the proposed configuration of antenna screen structure 20 are adjusted to form a second configuration of antenna screen structure 20. For example, at task 390, a designer may modify the geometrical parameter set of input variables (discussed above) by, for example, adjusting height 58 (FIG. 1), width 60 (FIG. 1), or thickness 50 of screen face 28. In addition or alternatively, the designer may add one or both of first and second beam members 64 and 66, respectively.

A designer may modify the geometrical parameter set of input variables in an attempt to discover a configuration of antenna screen structure 20 (FIG. 1) that is a lower cost and/or simpler construct than other antenna screen configurations, yet still exhibits sufficient structural integrity. By way of example, the adjustment of geometrical parameters at task 390 results in second configuration 62 (FIG. 3).

Following task 390, process control loops back to task 336, and antenna screen evaluation routine 338 (FIG. 19) is re-executed to evaluate second configuration 62 of antenna screen structure 20 (FIG. 3). The re-execution of task 336, results in the computation of second maximum deflection values of second configuration 62 in response to the adjusted geometrical parameters, the structural parameters, and the wind loading criteria. Accordingly the second maximum deflection values may be compared at query task 384, following the re-execution of task 336.

Referring back to table 366 (FIG. 20), second configuration 62 is identified by a second identifier 392, labeled “2”, in configuration identifier field 368 and deflection, weight, and cost values are summarized in table 366 in association with second identifier 392. In connection with query task 384, each of upper section, lower section, and beam deflection fields 376, 378, and 380 associated with second identifier 392 are examined. Since second configuration 62 includes first and second beam members 64 and 66, each of upper section deflection field 376, lower section deflection field 378 and beam deflection field 380 are considered. In addition, a total weight of 787 lb for second configuration 62 is summarized in total weight field 372, and a total cost of $8037.00 for second configuration is summarized in total cost field 374.

As shown, D_{MAX(upper)} is less than D_{LIM(upper)} for second configuration 62. Likewise, D_{MAX(lower)} is less than D_{LIM(lower)} and both D_{MAX(upper}_{_{—}}_{beam)} and D_{MAX(lower}_{_{—}}_{beam)} are less than D_{LIM(beam)}. The affirmative response at task 384 regarding deflection values of second configuration 62, indicates that second configuration 62 exhibits sufficient structural integrity to withstand wind loading at location 24 (FIG. 1), and process 332 proceeds to query task 386.

Query task 386 determines whether any the geometrical parameters are to be modified to further refine the design of antenna screen structure 20 (FIG. 1). Further refinement may be desirable to decrease weight and/or cost, or to simplify the design. For example, a designer may wish to modify the geometrical parameter set of input variables (discussed above) by, for example, adjusting height 58 (FIG. 1), width 60 (FIG. 1), or thickness 50 of screen face 28, or by adding or removing flanges and beam members. Query task 386 enables routine 338 to be an iterative process for assessing multiple configurations of an antenna screen structure to readily evaluate structural integrity versus cost, and to rapidly determine the cost impact of alterations to a configuration.

When no modifications to the geometrical parameter set of is 15 input variables are desired at query task 386, process 332 proceeds to a task 394 (discussed below). However, when modifications are desired, process control loops back to task 390 to adjust one or more of the geometrical parameters and re-execute antenna screen evaluation routine 338 (FIG. 19).

Referring back to table 366 (FIG. 20), third configuration 78 (FIG. 4) is identified by a third identifier 398, labeled “3”, in configuration identifier field 368 and deflection, weight, and cost values for third configuration 78 are summarized in table 366 in association with third identifier 396. As shown, data is summarized in upper section and beam deflection fields 376 and 380 and associated with third identifier 396. Since third configuration 396 includes only first beam member 64, lower section deflection field 378 and D_{MAX(lower}_{_{—}}_{beam)} of beam deflection field 380 are not considered. In addition, a total weight of 747 lb for third configuration 166 is summarized in total weight field 372, and a total cost of $7976.00 for third configuration 78 is summarized in total cost field 374.

As shown, both D_{MAX(upper)} and D_{MAX(upper}_{_{—}}_{beam)} are less than their respective deflection limits, D_{LIM(upper)} and D_{LIM(beam)}. Thus, process 332 proceeds to query task 386 to determine whether further modifications of geometrical parameters are desired. A negative response to query task 386 cause program control to proceed to a task 398.

At task 398, the deflection values, total weights, and costs of each configuration of antenna screen structure 20, evaluated through execution of antenna screen evaluation routine 338, are compared. Of note in the exemplary embodiment, table 366 (FIG. 20) shows that third configuration 78, identified by third identifier 396, exhibits sufficient structural integrity at a lower weight and lower cost than second configuration 62, identified by second identifier 392.

A task 400 is performed in cooperation with task 398 to select and finalize one of the configurations of antenna screen structure 20 (FIG. 1). Since third configuration 78 (FIG. 4) exhibits sufficient structural integrity at a lower weight and lower cost than second configuration 62 (FIG. 3), the designer may opt to select third configuration 166 for antenna screen structure 20 (FIG. 1). Finalization activities associated with selection of an antenna screen structure configuration entail confirming that the existing structure of building 26 is acceptable for the size and shape of third configuration 78; producing detailed drawings of the antenna screen structure, internal structure, connections, and installation information; developing a manufacturing process, tooling and mold designs; obtaining permitting; developing a matching finish texture and color specimen; and so forth.

Following task 400, a task 402 is performed. At task 402, a tooling table system is arranged to create a mold for the selected antenna screen structure configuration. Thus, following the planning activities of task 400, the manufacturing activities of process 332 are initiated at task 402.

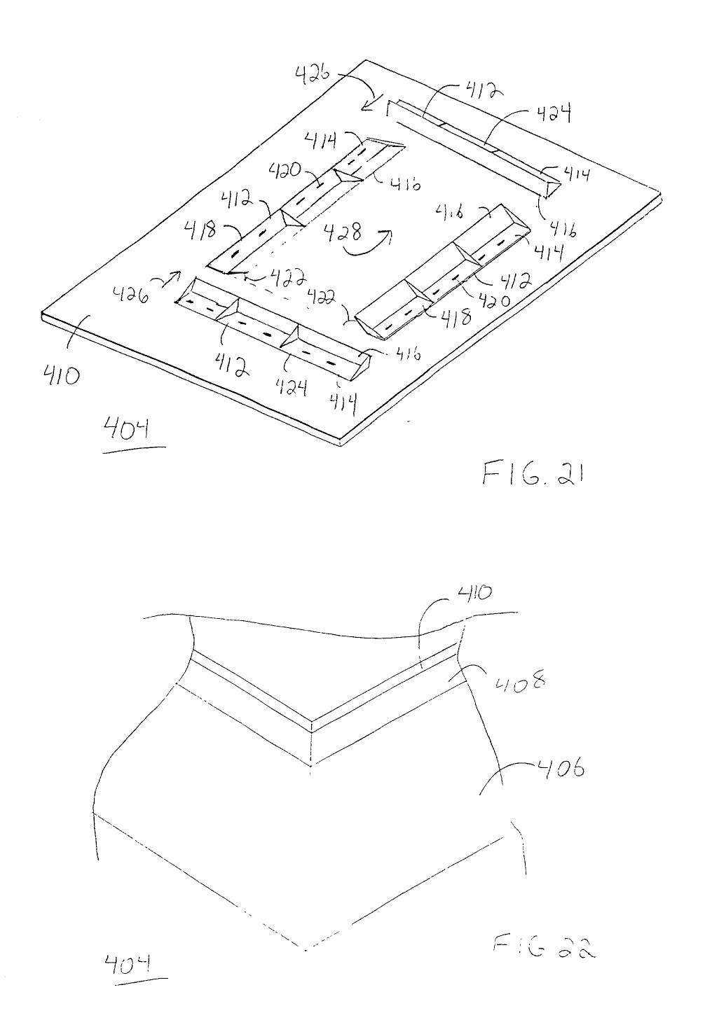

Referring to FIGS. 21-22 in connection with task 402, FIG. 21 shows a perspective view of a tooling table system 404 for producing an antenna screen structure, such as those described in connection with FIGS. 1-17. FIG. 22 shows an enlarged perspective view of a portion of tooling table system 404. Tooling table system 404 is employed to create molds for producing the various antenna screen configurations including the integral flange and/or beam structures of the varied configurations. In a preferred embodiment, tooling table system 404 is approximately twenty foot long by twelve foot wide. As such, the finished size of a screen face of the antenna screen structure is no greater than twenty by twelve feet.

Tooling table system 404 includes a frame structure 406, a deck 408 coupled to and overlying frame structure 406, and a replaceable surface material 410 overlying deck 408. In a preferred embodiment, frame structure 406 is a steel structure for providing structural support. Deck 408 is of a wood construction, for example, plywood, to which wall forms 412 are temporarily anchored. Replaceable surface material 410 is a flexible paper product for preventing the manufactured antenna screen structure from sticking to deck 408. Tooling table system further includes a plurality of wall forms 412, of which four are shown. Each of wall forms 412 includes a deck surface 414 configured for attachment to deck 408 and a wall surface 416 extending from deck surface 414 and contoured to effect a final shape of peripheral support 30 (FIGS. 1-5 and 10).

In an exemplary scenario, a first pair 418 of wall forms 412 are arranged opposite one another upon replaceable surface material 410 and the respective deck surfaces 414 are attached to deck 408 using fasteners 420. Wall surface 416 of each of first pair 418 extends from deck surface 414 at an angle greater than ninety degrees, for example, one hundred thirty five degrees, so that an angle 422 formed between replaceable surface material 410 and wall surface 414 is less than ninety degrees, for example forty five degrees.

A second pair 424 of wall forms 412 are arranged opposite one another upon replaceable surface material 410 and attached to deck 408. Wall surface 416 of each of second pair 424 extends from deck surface 414 at an angle of approximately ninety degrees. Second pair 424 are shown being moved into a final position, as represented by arrows 426. When in their final position, each of second pair 424 will abut opposite ends of each of first pair 418 of wall forms 412.

In this final position, a mold 428 is formed for a desired configuration of the antenna screen structure. The combination of first pair 418 of wall forms 412 and second pair 424 of wall forms results in mold 428 being configured to produce an antenna screen structure having angled vertical flange members, such as first and second vertical flange members 146 and 150, respectively, (FIG. 10) for producing flange joint 144.

Only four wall forms 412 and one mold 428 are shown for clarity of illustration. However, it should be understood that others of wall forms 412 may be arranged upon replaceable surface material 410 and attached to deck 408 to form a second mold (not shown) for another second configuration of the antenna screen structure.

Referring back to antenna concealment process 332 (FIG. 18), following task 402, a task 430 is performed. At task 430, antenna screen structure 20 (FIG. 1) is fabricated in the selected, finalized configuration, for example, third configuration 78, to imitate the appearance of building 26 (FIG. 1) at location 24 (FIG. 1). Fabrication activities entail establishing the construction and installation schedule and securing materials. Mold 428 (FIG. 21) is utilized at task 428 to fabricate antenna screen structure 20 from fiber reinforced plastic. For example, antenna screen structure 20 is formed by applying FRP into mold 428 to form first FRP layer 52 (FIG. 2) of screen face 28 (FIG. 1) and peripheral support 30 (FIG. 1). Thermoplastic honeycomb layer 56 (FIG. 2) and/or first and second beams 64 and 66 (FIG. 3) is then laminated onto first FRP layer 52, and second FRP layer 54 (FIG. 2) is laminated to thermoplastic honeycomb layer 56 and first and second beams 64 and 66.

Fabrication of antenna screen structure 20 at task 430 further entails integrating the surface finish texture and color into screen face 28 to imitate an appearance of building 26 at location 24, and inspecting and shipping antenna screen structure 20. The “finish” of screen face 28 can be color, texture, or both. A smooth screen face 28 may have a shallow texture. However, deeper convolutions may require the texture to be “molded-in” so that screen face 28 is formed to the profile of the material being duplicated. First FRP layer 52 may be pigmented to the final desired color of antenna screen structure 20. Alternatively, the final desired color of antenna screen structure 20 may be applied, i.e., painted onto screen face 28, following fabrication of structure 20.

A task 432 is performed following fabrication task 420. At task 432, antenna screen structure 20 is mounted at location 24 so that antenna 22 (FIG. 1) is hidden from an observer. Following task 432, antenna concealment process 332 exits.

In summary, the present invention teaches of various configurations of antenna screen structures for concealing a cell site radio frequency antenna are provided. The screen structures are configured to mitigate the potential for RF signal degradation through the use of large screen face surface area, peripherally located stiffeners, and thermoplastic honeycomb core. In addition, the present invention teaches of a method for concealing a cell site radio frequency (RF) antenna system that entails the use of a computer-based antenna screen evaluation routine, that evaluates a configuration of an antenna screen structure and rapidly assesses structural integrity, weight, and cost information. Through the execution of the routine the cost and structural impact of alterations to the antenna screen structure can be readily evaluated. Furthermore, the execution of the antenna screen evaluation routine within the antenna concealment process aids a designer to balance aesthetic effectiveness, RF degradation potential, structural integrity, and cost considerations in the design, fabrication, and installation of antenna screen structures. The present invention further teaches of a tooling table system that is readily and cost effectively arranged for creating molds for the various configurations of the screen structures.

Although the preferred embodiments of the invention have been illustrated and described in detail, it will be readily apparent to those skilled in the art that various modifications may be made therein without departing from the spirit of the invention or from the scope of the appended claims. For example, a wide variety of antenna screen structure shapes and sizes having the one piece FRP laminate structure, may be developed to best fit various cell site locations. In addition, the present invention will accommodate a wide variation in the specific tasks and the specific task ordering used to accomplish the processes described herein.

What is claimed is:

1. A screen structure for concealing a cell site radio frequency (RF) antenna at a location, said screen structure comprising:
an RF transparent screen face; and
a peripheral support integral to an edge of said screen face, said RF transparent screen face and said peripheral support forming a single unit.

2. A screen structure as claimed in claim 1 wherein said screen face comprises:
a first FRP layer;
a second FRP layer; and
a stiffener core interposed between said first and second FRP layers.

3. A screen structure as claimed in claim 2 wherein said stiffener core is a thermoplastic honeycomb core layer.

4. A screen structure as claimed in claim 1 wherein said RF transparent screen face and said peripheral support are formed as said single unit from fiber reinforced plastic (FRP).

5. A screen structure as claimed in claim 1 wherein:
said edge of said screen face is an upper edge;
said screen face further includes a lower edge, a first side edge, and a second side edge; and
said peripheral support includes a continuous flange member formed along each of said upper edge, said first side edge, said lower edge, and said second side edge.

6. A screen structure as claimed in claim 1 wherein said peripheral support includes a beam spanning a horizontal width of said screen structure.

7. A screen structure as claimed in claim 6 wherein:
said RF transparent screen face is formed from FRP; and
said beam is encased in said FRP of said screen face to form said single unit.

8. A screen structure as claimed in claim 6 wherein said beam is a box beam exhibiting a rectangular cross section and having a hollow interior passage.

9. A screen structure as claimed in claim 6 wherein said beam is a solid core beam.

10. A screen structure as claimed in claim 6 wherein said beam is a first beam, said edge is an upper edge, said screen face further includes a lower edge, and said peripheral support further comprises a second beam spanning said horizontal width of said screen structure at said lower edge.

11. A screen structure as claimed in claim 1 further comprising a horizontal support member integral to and spanning a horizontal width of said screen face, said horizontal support member being located at an intermediate position between an upper edge and a lower edge of said screen face.

12. A screen structure as claimed in claim 11 wherein:
said support member forms a border between an upper section and a lower section of said screen face;
said upper section of said screen face exhibits a first stiffness property; and
said lower section of said screen face exhibits a second stiffness property, said second stiffness property differing from said first stiffness property.

13. A screen structure as claimed in claim 1 further comprising an RF transparent vertical support member integral to and spanning a vertical height of said screen face, said vertical support member being located at an intermediate position between a first side edge and a second side edge of said screen face.

14. A screen structure as claimed in claim 1 wherein:
said edge is an upper edge;
said screen face further comprises a lower edge;
said peripheral support is formed along each of said upper and lower edges; and
said screen structure further comprises a first mounting bracket coupled to said peripheral support proximate said upper edge, and a second mounting bracket coupled to said peripheral support proximate said lower edge, said first and second mounting brackets being RF transparent, and said first and second mounting brackets being configured to retain said cell site RF antenna.

15. A screen structure as claimed in 1 wherein said edge is a side edge, and said peripheral support comprises a flange member formed along said side edge.

16. A screen structure as claimed in claim 15 wherein said RF transparent screen face is a first RF transparent screen face, said flange member is a first flange member, and said screen structure further comprises:
a second RF transparent screen face;
a second flange member integral to a second side edge of said second screen face, said second RF transparent screen face and said second flange forming a single unit; and
a fastener for coupling said second flange to said first flange to form a flange joint.

17. A screen structure as claimed in claim 16 wherein:
a first angle between said first flange member and said first RF transparent screen is less than ninety degrees;
a second angle between said second flange member and said second RF transparent screen is less than ninety degrees such that a bend in said screen structure is produced when said second flange member is coupled to said first flange member at said flange joint.

18. A screen structure as claimed in claim 16 further comprising:
a third flange member integral to a third side edge of said first screen face;
a fourth flange member integral to a fourth side edge of said second screen face;
a third RF transparent screen face;
a fifth flange member integral to a fifth side edge of said third screen face, said fifth flange member being coupled to said fourth flange member of said second screen face; and
a sixth flange member integral to a sixth side edge of said third screen face, said sixth flange member being coupled to said third flange member of said first screen face, wherein an interconnection of said first, second, and third screen faces establishes a triangular configuration of said screen structure.

19. A screen structure as claimed in claim 16 further comprising:
a third flange member integral to a third side edge of said first screen face;
a fourth flange member integral to a fourth side edge of said second screen face;
a third RF transparent screen face;
a fifth flange member integral to a fifth side edge of said third screen face, said fifth flange member being coupled to said fourth flange member of said second screen face; and
a sixth flange member integral to a sixth side edge of said third screen face, said sixth flange member being coupled to said third flange member of said first screen face, wherein said first, second, and third screen faces are arcuate-shaped members and an interconnection of said first, second, and third screen faces establishes a cylindrical configuration of said screen structure.

20. A screen structure as claimed in claim 16 further comprising:
a third flange member integral to a third side edge of said first screen face;
a fourth flange member integral to a fourth side edge of said second screen face;
a third RF transparent screen face;
a fifth flange member integral to a fifth side edge of said third screen face, said fifth flange member being coupled to said fourth flange member of said second screen face;
a sixth flange member integral to a sixth side edge of said third screen face;
a fourth RF transparent screen face;
a seventh flange member integral to a seventh side edge of said fourth screen face, said seventh flange member being coupled to said sixth flange member of said third screen; and
an eight flange member integral to an eight side edge of said fourth screen face, said eighth flange member being coupled to said third flange member of said first screen face, wherein said first, second, third, and fourth screen an interconnection of said first, second, third, and fourth screen faces establishes a box-shaped configuration of said screen structure.

21. A screen structure as claimed in claim 1 wherein:
said location is a parapet of said building;
said edge of said screen face is a lower edge;
said peripheral support comprises a flange member formed along said lower edge; and
said screen structure further comprises couplings configured to secure said flange to said parapet.

22. A screen structure as claimed in claim 21 wherein:
said screen face further includes an upper edge, a first side edge, and a second side edge; and
said screen structure further comprises:
a first support leg integral to said screen face and said peripheral support, said first support leg being positioned at a first lower corner of said screen face, said first lower corner being defined by said first side edge and a first end of said lower edge; and
a second support leg integral to said screen face and said peripheral support, said second support leg being positioned at a second lower corner of said screen face, said second lower corner being defined by said second side edge and a second end of said lower edge, said first and second support legs extending from said first and second lower corners and being configured to couple to said building.

23. A screen structure as claimed in claim 21 wherein:
said screen face further includes an upper edge, a first side edge, and a second side edge; and
said screen structure further comprises:
a first brace coupled at a first upper corner of said screen face, said first upper corner being defined by said first side edge and a first end of said upper edge; and
a second brace coupled at a second upper corner of said screen face, said second upper corner being defined by said second side edge and a second end of said upper edge, said first and second braces extending from said first and second upper edges and being configured to couple to said building.

24. A screen structure as claimed in claim 1 wherein a structural integrity of a configuration of said screen structure is automatically evaluated using executable code for instructing a processor to evaluate said configuration, said executable code instructing said processor to perform operations comprising:
defining geometrical parameters of said configuration;
receiving a wind load value for said location;
obtaining structural parameters of said configuration;
computing a maximum deflection value of said configuration in response to said geometrical parameters, said wind load value, and said structural parameters; and
comparing said maximum deflection value to a deflection limit value, wherein when said maximum deflection value is less than said deflection limit value said configuration of said antenna screen structure has acceptable structural integrity.

25. A screen structure as claimed in claim 1 wherein said screen structure is produced utilizing a tooling table system, said tooling table system including a frame structure, a deck coupled to and overlying said frame structure, a disposable surface material coupled to and overlying said deck, and a plurality of wall forms wherein selected ones of said wall forms are arranged upon said disposable surface material and attached to said deck to form a mold for a configuration of said antenna screen structure.

26. A method of producing an antenna screen structure for concealing a cell site radio frequency (RF) antenna at a location comprising:
defining geometrical parameters of a configuration of said antenna screen structure;
evaluating said configuration to determine whether said configuration exhibits acceptable structural integrity;
when said configuration exhibits acceptable structural integrity, arranging a tooling table system to create a mold for said configuration of said antenna screen structure;
utilizing said mold to fabricate said antenna screen structure from fiber reinforced plastic (FRP); and
integrating a surface finish into said antenna screen structure, said surface finish imitating an appearance of a structure at said location.

27. A method as claimed in claim 26 wherein said evaluating operation comprises:
defining geometrical parameters of said configuration;
receiving a wind load value for said location;
obtaining structural parameters of said configuration;
computing a maximum deflection value of said configuration in response to said geometrical parameters, said wind load value, and said structural parameters;
comparing said maximum deflection value to a deflection limit value; and
determining that said configuration of said antenna screen structure has acceptable structural integrity when said maximum deflection value is less than said deflection limit value.

28. A method as claimed in claim 26 wherein said tooling table system includes a frame structure, a deck coupled to and overlying said frame structure, a replaceable surface material overlying said deck, and a plurality of wall forms, and said arranging operation comprises:
arranging selected ones of said wall forms upon said disposable surface material to create said mold for said configuration of said antenna screen structure; and
attaching a deck surface of each of said wall forms to said deck such that a wall surface of said wall forms extend from said deck surface, said wall surface being contoured to effect a final shape of said peripheral support.

29. A tooling table system for producing an antenna screen structure configured to conceal a cell site radio frequency (RF) antenna, said antenna screen structure including an RF transparent screen face and a peripheral support integral to an edge of said screen face, and said tooling table system comprising:
a frame structure;
a deck coupled to and overlying said frame structure;
a replaceable surface material overlying said deck; and
a plurality of wall forms wherein selected ones of said wall forms are arranged upon said replaceable surface material and attached to said deck to form a mold for a configuration of said antenna screen structure.

30. A tooling table system as claimed in claim 29 wherein others of said plurality of wall forms are arranged upon said replaceable surface material and attached to said deck to form a second mold for a second configuration of said antenna screen structure.

31. A tooling table system as claimed in claim 29 wherein said wall forms comprise:
a deck surface configured for attachment with said deck; and
a wall surface extending from said deck surface and contoured to effect a final shape of said peripheral support.
